(19) United States
(12) Patent Application Publication
(10) Pub. No.: US 2003/0093428 A1
(43) Pub. Date: May 15, 2003

(54) Interactive browsing system

(76) Inventors: Shingo Suzumori, Fukuoka (JP); Yayoi Nakamura, Fukuoka (JP); Ryuji Sakunaga, Fukuoka (JP); Hiroshi Sugitani, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/115,454

(22) Filed: Apr. 3, 2002

(30) Foreign Application Priority Data
Nov. 12, 2001 (JP) 2001-345535

(51) Int. Cl. G06F 7/00

(52) U.S. Cl. 707/10

(57) ABSTRACT

Disclosed is an interactive browsing system for acquiring target information in a prescribed information page, which exists at a prescribed site on a network, in response to a request from a user. The system includes a knowledge management unit for storing knowledge necessary to acquire a keyword of a utilizable information page; a human-like agent for analyzing a request, which the user has entered, using the knowledge, and extracting a keyword conforming to the user request; and a browser (data analyzing unit) for acquiring desired target information from the network using the keyword, and outputting this target information to an input/output unit in an appropriate format.

### BACKGROUND OF THE INVENTION

This invention relates to an interactive browsing system for acquiring desired Web page information (target information), which exists at a prescribed site on a network typified by the Internet, in response to a request from a user. More particularly, the invention relates to an interactive browsing system in which a man-machine interface for when a network service is utilized is improved so as to enable target information to be acquired in a simple manner.

The spread of information technology (IT) has reached into the ordinary home, and a variety of network services are now being provided. However, man-machine interfaces according to the prior art are not thoughtfully designed for individuals who are not accustomed to personal computers and network services and individuals who are challenged by the use thereof, especially the elderly, and it is very difficult for these individuals to utilize network services. Thus a gap has arisen between those who can utilize network services and those who cannot. This gap, referred to as the “digital divide”, has become a matter of concern. As the spread of network services is predicted to continue into the future, there is demand for a man-machine interface that can be used easily by the aforementioned individuals, especially the elderly, who have difficulties with personal computers and network services.

The technique set forth below has been proposed as a man-machine interface and method of using the same when a network service is utilized. FIG. 26 is a block diagram of a browsing system according to the prior art, and FIG. 27 is an explanatory view illustrating the concept of information-page browsing according to the prior art. A browsing system in incorporated in a personal computer, which is the client machine, and includes a data input/output unit 1 such as a keyboard, mouse, monitor, microphone and speakers, an input/output controller 2 for controlling data input/output with respect to the data input/output unit 1 and for controlling data input/output with respect to a network NWK, and a data analyzer (browser) 3. The data analyzer 3 is connected to the input/output controller 2 and incorporates a Web browser (software) 3a which, in response to a user request, executes processing for acquiring target information that exists at prescribed sites 4, 5, . . . (FIG. 27) on the network NWK, and processing for analyzing data that is sent and received.

Processing Executed by Web Browser 3a for Browsing Information Pages (Web Pages)

Information concerning a top page (home page) written in HTML (HyperText Markup Language) is displayed on the monitor 1 under the control of the Web browser 3a. Embedded in this information page are items of link information (referred to below as “anchors”) for pursuing information pages relating to this page, other information pages and data such as files. A user repeatedly performs an operation that entails entering a keyword related to target information by using the input unit such as the keyboard and mouse, or clicking on an anchor, which is being displayed on the monitor, by a mouse or the like. As a result, layers of information pages are pursued one at a time up to the information page that carries the target information, as indicated by the solid line (request 1) or dashed line (request 2) in FIG. 27, the desired target information is acquired and the information is displayed on the monitor (data input/output unit) 1.

Processing for Browsing Information Pages by VoiceXML

FIG. 28 is a conceptual drawing illustrating utilization of VoiceXML (Voice extensible Markup Language). In FIG. 28, (a) is an example of a description in VoiceXML. When a user accesses this information page, guidance is announced by voice in the following manner, as indicated at (b) in FIG. 28:

WELCOME TO THE ◯◯◯ WEB PAGE. HOW CAN WE HELP YOU? ANSWER AS BY SAYING ‘TRASH DISPOSAL NEXT WEEK’. WHAT WOULD YOU LIKE TO DO?

At this time it is also possible to create a special-purpose Web browser (VoiceXML browser) and present a display on a screen.

When the user verbally enters a keyword, which is defined between <grammar> and </grammar>, in response to the guidance, processing of the corresponding field is executed. For example, if “TRASH DISPOSAL” has been entered by voice, then the condition “WHEN” is regarded as “THIS WEEK”, “DISPLAY THIS WEEK'S TRASH DISPOSAL” is output by voice and a transition is made to the applicable page.

If words other than the keyword defined between <grammar> and </grammar> are entered by voice, e.g., if “THIS MONTH” is entered by voice, then the following is output by voice:

THE “GENRE (req)” CONDITION IS INSUFFICIENT. IN WHAT GENRE ARE YOU INTERESTED?”

and the system stands by for a voice input.

Further, if “TRASH”, which is a word other than the keyword defined between <grammar> and </grammar>, is entered by voice, no response is given or the message at (b) is repeated, as indicated at (d) in FIG. 28.

Thus, in processing for browsing information pages by VoiceXML, information and operation logic are written in VoiceXML to obtain an information page, a VoiceXML interpreter interprets this information and the operation such as an outline of operations set forth on the information page are interpreted and these are output as voice. Embedded in the information page are \mathring{1} a voice-recognizable keyword for pursuing information pages relating to this page, information pages of other sites, and data such as files, and \mathring{2} logic for outputting, as a voice message, an outline of operations by the user on the same page.

In processing for browsing information pages by VoiceXML as well, a voice input unit such as a microphone and a voice output unit such as a speaker are used, the user verbally enters an operation keyword or the like by the microphone in accordance with the information and outline of operations output as voice by the speaker, and the user must pursue layers of information pages one by one up to the page carrying the target information. Furthermore, since the VoiceXML technique does not possess a function for displaying information, as is possible with the conventional Web browsers, the VoiceXML interpreter employs a method such as putting information into the form of a Web page, launching a voice Web browser independently and displaying the information.

Other Prior Art

The specification of Japanese Patent Application Laid-Open No. 2001-75987 (P2001-75987A) proposes a system for assisting the discovery of target information in an information search activity, which is for gathering target information, by displaying a large quantity of information such as Web pages that are the target of a search on a screen in a short period of time. Implementation of the so-called “Semantec Web” is being promoted by the W3C (World-Wide Web Consortium), a Web-related standardization facility. The Semantec Web involves a proposed technique for enhancing user convenience by creating a Web page using markup language that defines the meaning of data and the relationships among items of data, and analyzing the Web page by machine. Furthermore, “V Portal”, which is provided by NTT Communications, proposes a service through which acquisition of content compiled in the VoiceXML format is requested by the user from a telephone by voice and is obtained from the telephone by voice.

The art disclosed in the specification of Japanese Patent Application Laid-Open No. 2001-75987 (P2001-75987A) allows the user to display a large quantity of information, which is for facilitating the discovery of target information, on a screen. However, finding the target information and acquiring the target information from among the displayed information instantaneously is difficult for the aforementioned individuals, especially the elderly, who are challenged by utilization of personal computers and network services. In addition, the information output means that expedites the finding of target information is limited to the display screen.

The Semantec Web is art relating to markup language, which can be interpreted by machine, that defines the meaning of data and the relationships among items of data on a Web page. This technique does not provide the optimum response to a user request.

“V Portal” is a service in which an information acquisition request is made by voice from a telephone and information is output by voice. Means for accessing information is limited to a single medium, namely voice, and information must be accessed in stages.

Thus, the prior art involves the following challenges from the viewpoints of user friendliness and creation of the information pages:

User Friendliness

According to the prior art, layers of information pages must be pursued one at a time until the target information is acquired. This repetitive operation is troublesome and inefficient. Specifically, the concept of browsing information pages according to the prior art is as shown in FIG. 27, in which a number of steps are needed for the user to finally acquire the target information. Further, anchors, voice-recognizable keywords, messages such as the outline of operation and operation logic that are embedded in an information page are effective only in the page in which they are embedded, and information pages in layers below this information page cannot be freely selected and input, and information cannot be acquired directly.

For the aforementioned individuals, especially the elderly, who have difficulties with personal computers and network services, the prior-art browsing system does not provide sufficient guidance for acquiring network services.

With regard to anchors, voice-recognizable keywords, messages such as the outline of operation and operation logic that are embedded in an information page, which will be selected and input and which related operations will be performed when the page is utilized by the user must be anticipated and these must be embedded in advance. As a consequence, this system cannot provide suitable guidance on a user-by-user basis because it lacks flexibility. Further, even though a large quantity of information that makes it easier for the user to find target information is displayed on a display screen, it is difficult to find and acquire the target information among the displayed items of information instantaneously. In addition, the information output means for facilitating the discovery of target information is limited to the display screen.

Creation of Information Pages

In order to achieve user friendliness to the maximum extent and in order to satisfy all requests, anchors, voice-recognizable keywords and operation logic for leading the user to the target information cannot readily be predicted and it is difficult to embed them in all information pages in advance. Even if this were feasible, the creator of the information page must invest a great amount of time and expense to create user-aware information pages and to maintain these pages as by updating the same.

It is anticipated that standardizing the “Semantec Web” will take time and will not result in a system that takes into consideration the aforementioned individuals, especially the elderly, who have difficulties with personal computers and network services. It is difficult to maintain that this will provide a man-machine interface (environment) that will enable anyone to exploit network services. The aforementioned individuals, especially the elderly, who have difficulties with personal computers and network services will not be able to utilize personal computers and network services positively and will lose interest in them, thus widening the digital divide.

### SUMMARY OF THE INVENTION

Accordingly, an object of the present invention is to so arrange it that target information can be acquired in a simple manner by improving a man-machine interface employed when a network service is utilized.

Another object of the present invention is to improve operability, thereby preventing widening of the digital divide, by reducing the number of operations or number of times requests are input to acquire target information.

Another object of the present invention is to make it possible to create an information page simply in a manner similar to that heretofore without requiring creation of a user-aware information page.

A further object of the present invention is to so arrange it that target information can be acquired using the latest access-destination information.

A further object of the present invention is to so arrange it that target information can be output in an output format that takes into consideration the structure of input/output units of a browsing system as well as user information.

According to the present invention, the foregoing objects are attained by providing a system for performing control for acquiring information (target information) in a prescribed information page, which exists at a prescribed site on a network, in response to a request from a user, comprising: (1) a knowledge management unit for storing knowledge necessary to acquire a keyword of a utilizable information page; (2) data conversion means for converting request data from the user to data necessary to acquire the keyword; (3) an agent for extracting a keyword of a prescribed information page, which is in compliance with the user request, using the knowledge and data obtained by the conversion; and (4) means (a browser) for performing control for acquiring desired target information from the network using the keyword.

In this interactive browsing system, the data conversion means extracts a word, which is necessary to acquire the keyword of the prescribed information page, from the request data entered by the user, and the agent acquires the keyword, which is in compliance with the word, based upon the knowledge. The browser acquires the desired target information from the network using the acquired keyword and outputs the desired target information from an input/output unit as voice or text or both.

The knowledge management unit stores knowledge for generating navigation that provides guidance appropriately until the target information is acquired. If the agent cannot acquire the keyword of the prescribed information page from the word extracted from the request, which has been entered by the user, and the knowledge, then the agent generates navigation necessary to acquire the keyword, outputs the navigation from the input/output unit and acquires the keyword by referring to a reply from the user in response to the navigation.

More specifically, the knowledge management unit stores (1) user information having information relating to personal attributes, operating characteristics and operating history; (2) access-destination information having hierarchical structure information of information pages inclusive of utilizable information pages and information pages of lower hierarchical layers, and keywords of these information pages; (3) a dictionary of phrases, such as operating guidance or the like, necessary for interaction with the user; and (4) a navigation template for generating navigation that provides guidance appropriately until the user acquires the target information. The data conversion means extracts a word, which is necessary to acquire the keyword of the prescribed information page, from the request data entered by the user, the agent acquires the keyword, which is in compliance with the word, based upon the knowledge, and the browser acquires the desired target information from the network using the acquired keyword and outputs the desired target information from the input/output unit as voice or text or both.

Means for acquiring access-destination information acquires the latest access-destination information automatically from a prescribed site on the network whenever target-information acquisition processing is executed, or at a timing specified by the user, or periodically, and the knowledge management unit updates old access-destination information to the latest access-destination information.

In accordance with the interactive browsing system according to the present invention set forth above, target information can be acquired in simple manner by improving the man-machine interface used when a network service is utilized. Further, it is possible to improve operability by reducing the number of operations or number of request inputs required to acquire target information. This makes it possible to prevent widening of the digital divide. Further, in accordance with the interactive browsing system of the present invention, it is possible to create an information page simply in a manner similar to that heretofore without requiring creation of a user-aware information page. Further, target information can be acquired using the latest access-destination information. Moreover, target information can be output in an output format that takes into consideration the structure of input/output units of a browsing system and user information.

Other features and advantages of the present invention will be apparent from the following description taken in conjunction with the accompanying drawings.

### BRIEF DESCRIPTION OF THE DRAWINGS

FIG. 1 is a block diagram of an interactive browsing system according to the present invention;

FIG. 2 is a diagram useful in describing the concept of browsing of information pages according to the present invention;

FIG. 3 is a diagram useful in describing an abbreviated operation according to the present invention;

FIG. 4 illustrates a first example of a configuration in which all units are incorporated in a client machine (personal computer) of a user;

FIG. 5 illustrates a second example of a configuration in which a human-like agent and a knowledge management unit are incorporated in a server machine connected to a network;

FIG. 6 illustrates a third example of a configuration in which the functions and data of a human-like agent and knowledge management unit are distributed between a client machine of a user and server machine;

FIG. 7 is a first explanatory view of access-destination information acquisition processing executed by a link processor;

FIG. 8 is a second explanatory view of access-destination information acquisition processing executed by a link processor;

FIG. 9 is a diagram useful in describing access-destination information;

FIG. 10 is a diagram useful in describing an output format conversion performed by a media processor;

FIG. 11 illustrates the configuration of a system to which the present invention is applied;

FIG. 12 is a block diagram illustrating an interactive Web browsing system for a case where all units are incorporated in a client machine of a user;

FIG. 13 is a block diagram illustrating an interactive Web browsing system for a case where a human-like agent and a knowledge management unit are incorporated in a server machine;

FIG. 14 is a block diagram illustrating an interactive Web browsing system for a case where a human-like agent and a knowledge management unit are distributed between a client machine and a server machine;

FIG. 15 illustrates an example of the structure of knowledge information (user information) managed by a knowledge management unit;

FIG. 16 illustrates an example of the structure of knowledge information (navigation know-how information) managed by a knowledge management unit;

FIG. 17 illustrates an example of the structure of knowledge information (navigation template) managed by a knowledge management unit;

FIG. 18 is a flowchart of processing for registering access-destination information;

FIG. 19 is a flowchart of processing for registering user information;

FIG. 20 is a flowchart of processing for generating navigation;

FIG. 21 is a flowchart of processing for media conversion;

FIG. 22 is a flowchart of processing for acquiring target information;

FIG. 23 is a diagram useful in describing target information and navigation output format;

FIG. 24 is a flowchart of processing for extracting an execution keyword;

FIG. 25 is a processing routine for generating querying navigation;

FIG. 26 is a block diagram of a browsing system according to the prior art;

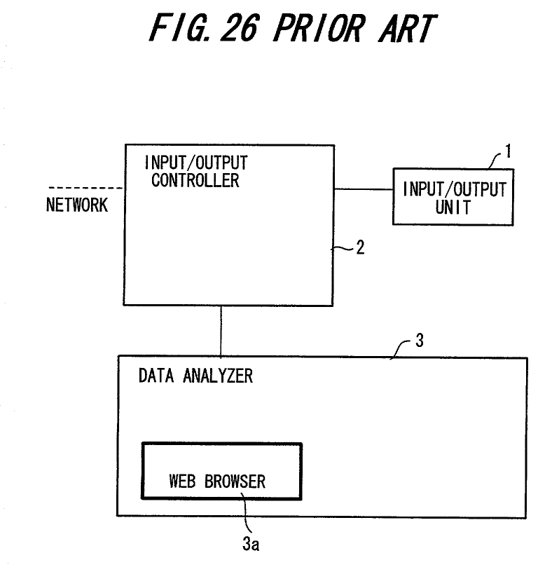

FIG. 27 is an explanatory view illustrating the concept of browsing of information pages according to the prior art; and

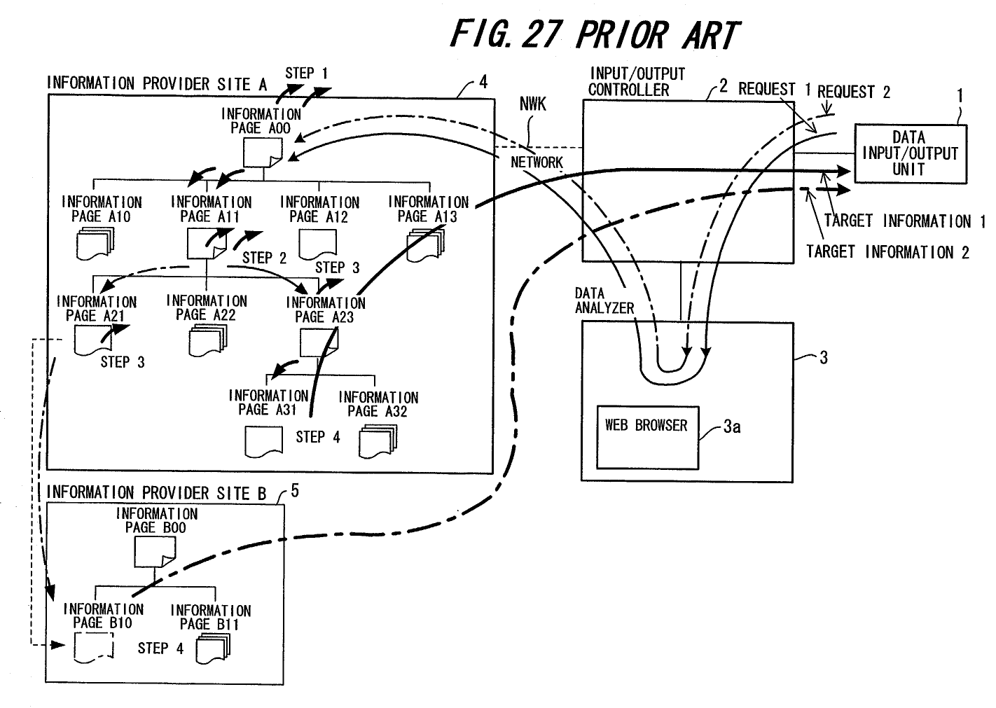

FIG. 28 is a diagram showing markup in VoiceXML and explaining VoiceXML.

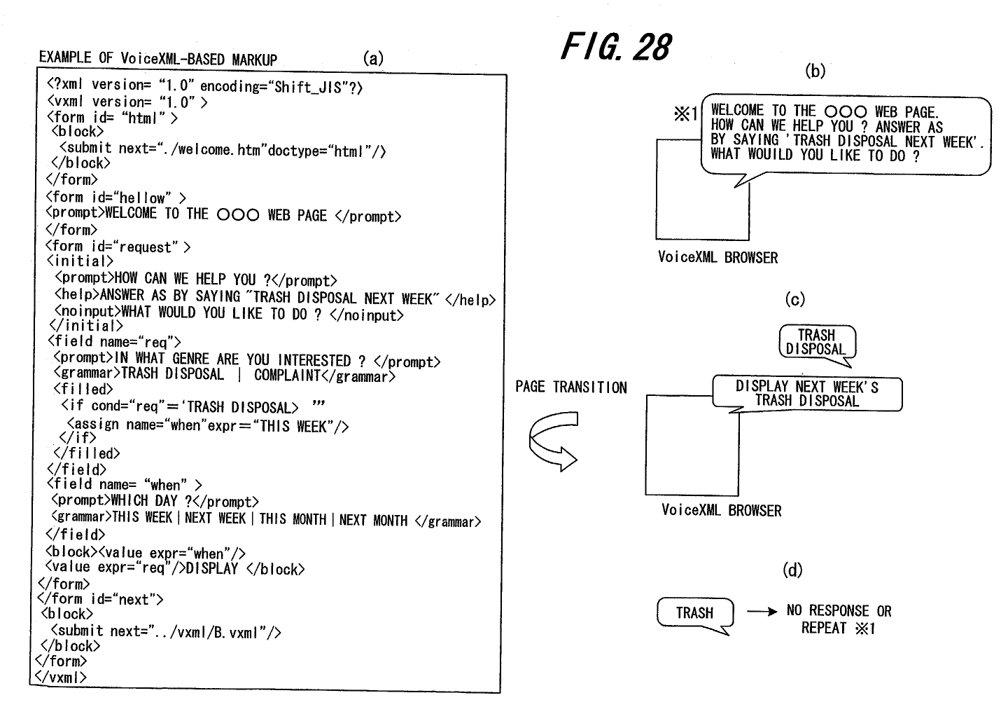

### DESCRIPTION OF THE PREFERRED EMBODIMENTS

(A) Overview of the invention

(a) Configuration

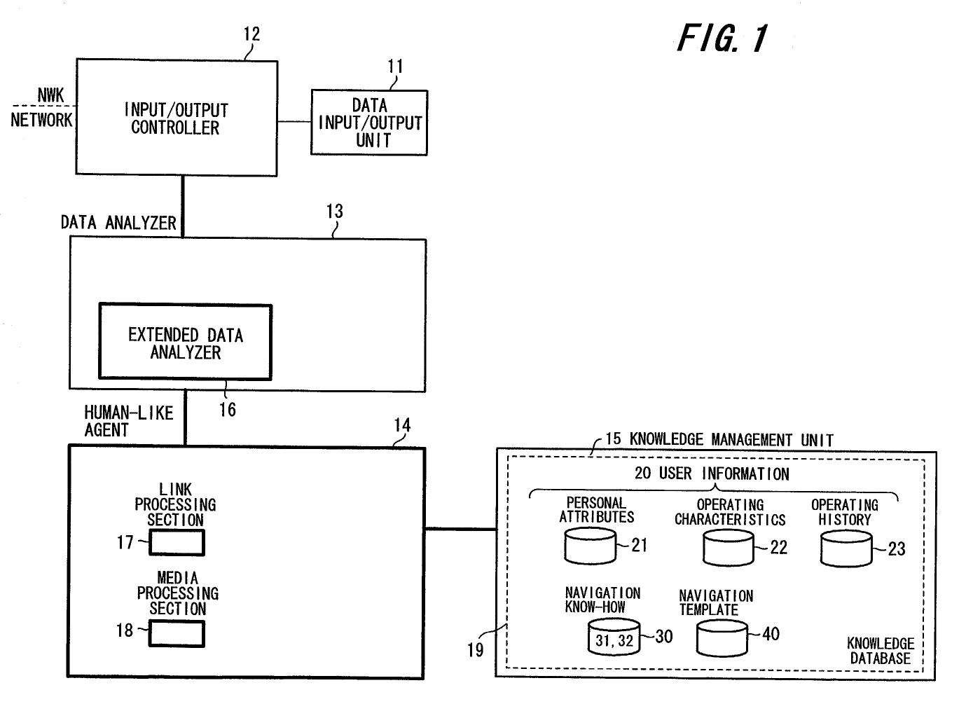

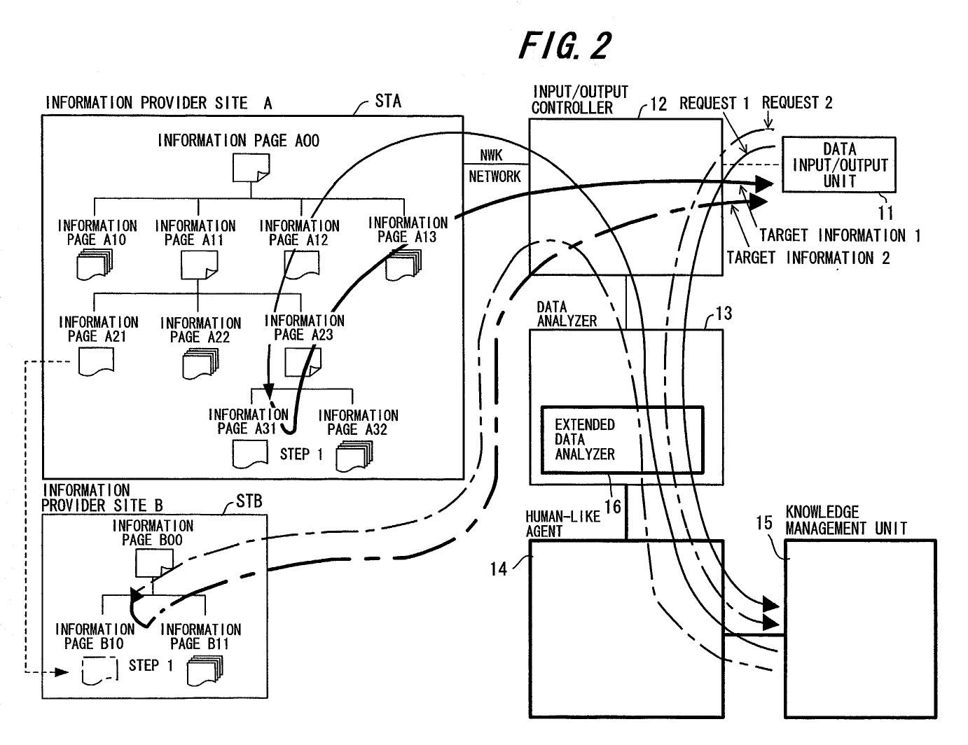

FIG. 1 is a block diagram of an interactive browsing system according to the present invention, and FIG. 2 is a diagram useful in describing the concept of browsing of information pages according to the present invention. The interactive browsing system includes a data input/output unit 11 such as a keyboard, mouse, monitor, microphone and speakers, an input/output controller 12 for controlling data input/output with respect to the data input/output unit 11 and for controlling data input/output with respect to a network NWK, a data analyzer (browser) 13 incorporating a Web browser (software) which, in response to a user request, executes control for acquiring information (target information) of a prescribed information page that exists at a prescribed site on the network NWK, a humanlike agent 14 for extracting a keyword of the prescribed information page that is in compliance with the user request, and a knowledge management unit 15 for storing knowledge necessary to acquire a keyword of a utilizable information page.

The data analyzer 13 has an extended data analyzer 16. The latter extracts a word, which is necessary to extract the keyword of the prescribed information page, from request data entered by the user, and delivers the extracted word to the human-like agent 14. Using the keyword extracted by the human-like agent 14, the data analyzer 13 executes processing for acquiring target information that exists at information provider sites A (STA), B (STB), . . . (FIG. 2) on the network NWK.

In addition to the section for implementing the function that extracts the keyword of a prescribed information page in compliance with the user request, the human-like agent 14 also has a link processing section 17 and a media processing section 18. The link processing section 17 acquires the latest access-destination information from a prescribed site on the network automatically whenever target-information acquisition processing is executed, or at a timing specified by the user, or periodically. The media processing section 18 converts the response data to the proper output format based upon the structure of the apparatus employed by the user and the user information.

The knowledge management unit 15 manages a knowledge database 19, which stores \mathring{1} user information 20 having information relating to personal attributes 21, operating characteristics 22 and operating history 23; \mathring{2} navigation know-how information 30 such as access information (which has hierarchical structure information of information pages inclusive of utilizable information pages and information pages information pages, and keywords of these information pages) 31 and a dictionary 32 of phrases, such as operating guidance or the like, necessary for interaction with the user; and \mathring{3} a navigation template 40 for generating navigation (guidance messages) dynamically as by making combinations.

In use, the access-destination information 31 of interest is registered and stored beforehand in the knowledge database 19 managed by the knowledge management unit 15 under the control of the link processing section 17 of human-like agent 14. Further, \mathring{1} the user information 20 such as the personal attributes 21 of the user, operating characteristics 22 and operating history 23, \mathring{2} the navigation know-how information 30 such as the dictionary 32 of phrases necessary for interaction with the user, and \mathring{3} the navigation template 40 for dynamically generating the optimum navigation in compliance with the apparatus used by the user and circumstances of the user are registered and stored in the knowledge database 19.

If there is a request from a user under these conditions, the extended data analyzer 16 extracts a word, which is necessary to acquire a keyword of a prescribed information page, from the request data that has been entered by the user, and the human-like agent 14 acquires the keyword that conforms to this word based upon the knowledge 20 to 40. In this case, if the human-like agent 14 cannot acquire the keyword of the prescribed information page from the word extracted from the request, which has been entered by the user, and the knowledge, then the agent generates navigation necessary to acquire the keyword, outputs the navigation from the input/output unit 11 and acquires the keyword by referring to an answer from the user in response to this navigation.

Using the keyword acquired, the data analyzer 13 acquires desired target information 1 or desired target information 2 from the prescribed site STA or STB on the network NWK by a single information-page send/receive step, and outputs the target information from the data input/output unit 11 as voice or text or both, as indicated by the solid line (request 1) or broken line (request 2) in FIG. 2.

Thus, the interactive browsing system of the present invention analyzes the user request, obtains a keyword and acquires the target information directly by using the keyword. Further, if a keyword is not obtained, the system dynamically generates optimum navigation that conforms to the apparatus employed by the user and the circumstances of the user, obtains the keyword by referring to a reply obtained from the user and acquires the target information directly using this keyword. In other words, the interactive browsing system according to the present invention guides the user until the keyword is acquired. Once the keyword has been acquired, the system acquires the target information directly (by a single information-page send/receive step).

As a result, with the browsing system of the present invention, the user need not be made aware of the sites at which various information pages exist, link information to these information pages and the hierarchical structure thereof, a repetitive operation performed up to acquisition of the target information is eliminated and it is possible to reduce the number of steps performed by the user to acquire the target information.

(b) Abbreviated Operation

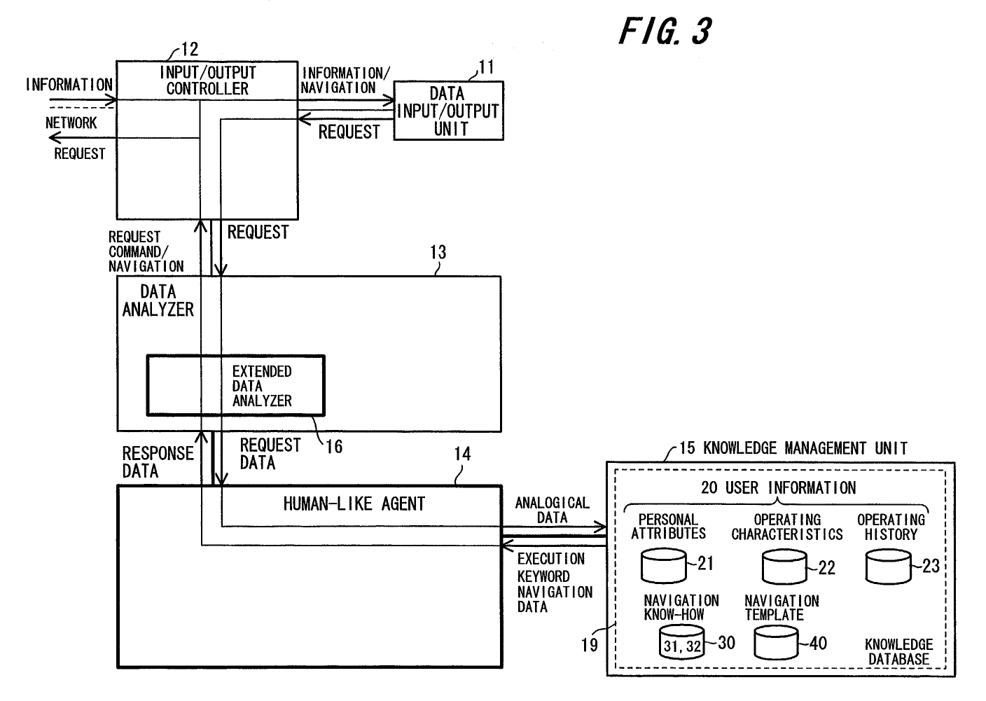

FIG. 3 is a diagram useful in describing an abbreviated operation according to the present invention. Components identical with those shown in FIG. 1 are designated by like reference characters.

It is assumed that following information has been registered in the knowledge database 19 of knowledge management unit 15 in advance:

the access-destination information 31 of interest;

the user information 20 such as the personal attributes of the user, operating characteristics and operating history;

the navigation know-how information such as the dictionary 32 of phrases necessary for interaction with the user; and

the navigation template 40 for dynamically generating the optimum navigation in compliance with the apparatus used by the user and circumstances of the user.

(101) First, the user enters a request from the data input/output unit 11.

(102) The data input/output unit 11 delivers the request to the input/output controller 12.

(103) The input/output controller 12 delivers the received request to the data analyzer 13.

(104) The extended data analyzer 16 of data analyzer 13 converts the request entered by the user to processable data (referred to as “request data” below).

(105) The extended data analyzer 16 delivers the request data to the human-like agent 14.

(106) Using the user information 20, such as the personal attributes of the user, operating characteristics and operating history, and the access-destination information 31 managed by the knowledge management unit 15, the human-like agent 14 extracts condition data (referred to as an “execution keyword” below), which is for acquiring target information, from the request data. For example, if “THIS MONTH'S TRASHCOLLECTION DATE INFORMATION FOR DISTRICT a” is the target information, the execution keyword will be a keyword for acquiring this target information from an information provider site.

(107) Using the navigation know-how information 30 and the navigation template 40, which are managed by the knowledge management unit 15, and the execution keyword that has been extracted, the human-like agent 14 generates navigation that is indicative of the gist of the target information. For example, the navigation is “THIS MONTH'S TRASH-COLLECTION DATE INFORMATION FOR DISTRICT a. IS THIS ACCEPTABLE?”

(108) On the basis of the structure of the input/output unit employed by the user and the navigation know-how information 30, the human-like agent 14 converts this navigation data to a proper output format.

(109) The human-like agent 14 thenceforth delivers data (referred to as “response data” below), which is a combination of the execution keyword and navigation, to the data analyzer 13.

(110) The extended data analyzer 16 of data analyzer 13 extracts the execution keyword and navigation from the response data and generates target-information acquisition request data (referred to as a “request command” below) that includes the execution keyword.

(111) The extended data analyzer 16 delivers the request command and navigation to the input/output controller 12.

(112) The input/output controller 12 acquires the target information from the prescribed information sites STA, STB via the network NWK based upon the request command and delivers the target information and navigation to the data input/output unit 11.

(113) The data input/output unit 11 outputs the target information and navigation to the user.

If the execution keyword cannot be acquired by steps (101) to (106) above, a similar execution keyword can be extracted and the user can check the request. For example, navigation (a guidance message) needed to acquire the execution keyword is generated and is output from the data input/output unit 11, and the execution keyword is acquired by referring to the reply from the user in response to this navigation. Further, it is possible to extract a keyword serving as the execution keyword, even if a perfect match is not achieved, by a so-called fuzzy search.

Thus, target information can be acquired directly without performing a repetitive operation and without the user being made aware of the sites at which various information pages exist, link information to these information pages and the hierarchical structure thereof. Further, navigation conforming to the apparatus used by the user and the circumstances of the user can be generated dynamically and the user is guided until the target information is acquired, thereby making it possible to obtain the optimum answer to the user request.

(c) Interactive browsing system

Several configurations are conceivable and depend upon whether the human-like agent 14 and knowledge management unit 15 constituting the browsing system of FIG. 3 are provided on the side of the user's client machine (personal computer) or on the side an external server connected to a network.

(c-1) First Example of Configuration

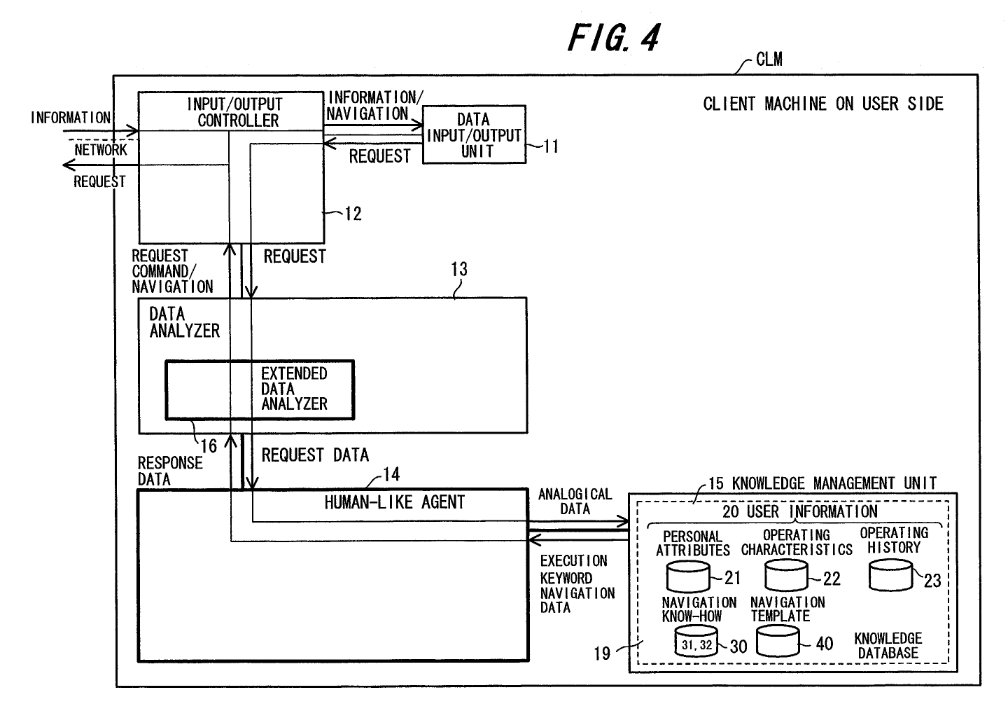

FIG. 4 illustrates a first example of a configuration in which all of units 11 to 16 are incorporated in a client machine (personal computer) CLM of a user. The abbreviated operation in this case is as set forth at steps (101) to (113) above.

(c-2) Second Example of Configuration

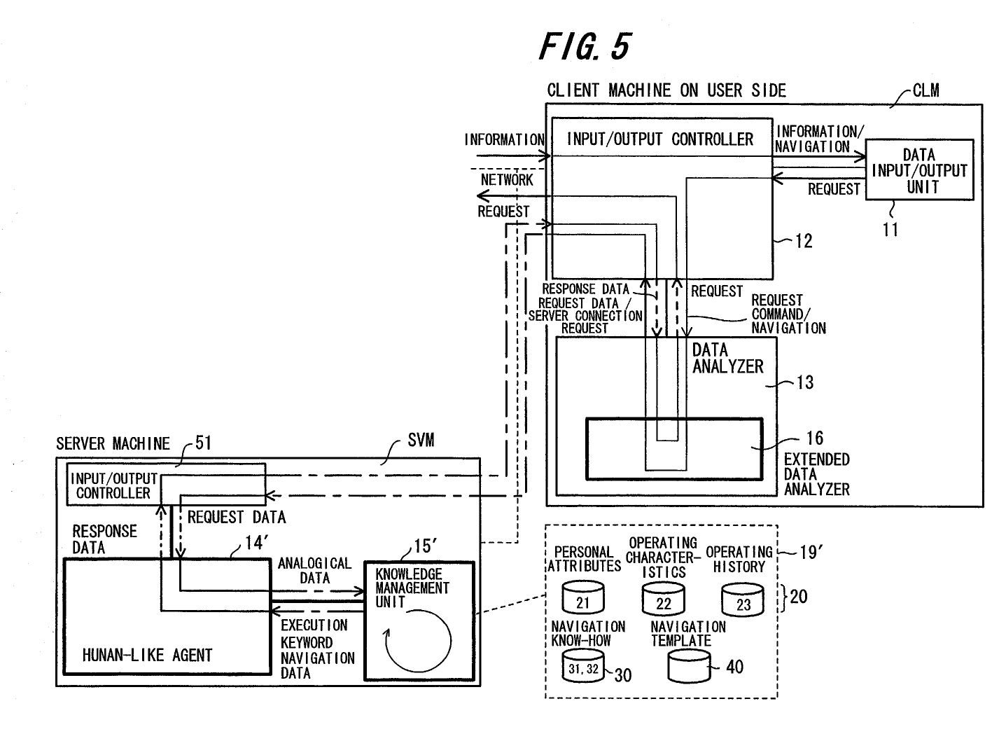

FIG. 5 illustrates a second example of a configuration in which a human-like agent 14′ and a knowledge management unit 15′ are incorporated in a server machine SVM connected to the network NWK. Here communication is performed between the extended data analyzer 16 on the side of the user's client machine CLM and the human-like agent 14′ on the side of the server machine SVM. It is assumed that the following information has been registered in the knowledge database 19′ of the knowledge management unit 15′.

the access-destination information 31 of interest;

the user information 20 such as the personal attributes of the user, operating characteristics and operating history;

the navigation know-how information such as the dictionary 32 of phrases necessary for interaction with the user; and

the navigation template 40 for dynamically generating the optimum navigation in compliance with the apparatus used by the user and circumstances of the user.

(201) First, the user enters a request from the data input/output unit 11.

(202) The data input/output unit 11 delivers the request to the input/output controller 12.

(203) The input/output controller 12 delivers the received request to the data analyzer 13.

(204) The extended data analyzer 16 of data analyzer 13 converts the request entered by the user to processable data (request data).

(205) The extended data analyzer 16 delivers this request data and a connection request, which is a request for connection to the server machine SVM, to the input/output controller 12.

(206) The input/output controller 12 delivers the request data to an input/output controller 51 on the side of the server machine SVM from the request for connection to the server machine SVM.

(207) The input/output controller 51 on the side of the server machine delivers the request data to the human-like agent 14′.

(208) Using the user information 20, such as the personal attributes of the user, operating characteristics and operating history, and the access-destination information 31 managed by the knowledge management unit 15′, the human-like agent 14′ extracts an execution keyword, which is for acquiring target information, from the request data.

(209) Using the navigation know-how information 30 and the navigation template 40, which are managed by the knowledge management unit 15′, and the execution keyword that has been extracted, the human-like agent 14′ generates navigation that is indicative of the gist of the target information. For example, the navigation is “THIS MONTH'S TRASH-COLLECTION DATE INFORMATION FOR DISTRICT a. IS THIS ACCEPTABLE?”

(210) On the basis of the structure of the input/output unit employed by the user and the navigation know-how information 30, the human-like agent 14′ converts and shapes this navigation data into a proper output format.

(211) The human-like agent 14′ thenceforth delivers response data, which is a combination of the execution keyword, as well as a request for connection to the client machine CLM, to the input/output controller 51.

(212) The input/output controller 51 of the servermachine delivers the response data to the input/output controller 12 on the side of the client machine in response to the request for connection to the client machine CLM.

(213) The input/output controller 12 delivers the response data to the data analyzer 13.

(214) The extended data analyzer 16 of data analyzer 13 extracts the execution keyword and navigation from the response data and generates target-information acquisition request data (the request command) that includes the execution keyword.

(215) The extended data analyzer 16 delivers the request command and navigation to the input/output controller 12.

(216) The input/output controller 12 acquires the target information from the prescribed information sites STA, STB via the network NWK based upon the request command and delivers the target information and navigation to the data input/output unit 11.

(217) The data input/output unit 11 outputs the target information and navigation to the user.

Thus, the functions and data of an interactive browsing system are managed in a unified manner to facilitate maintenance of the browsing system. In addition, regardless of the type of user, it is possible to provide the optimum response.

(c-3) Third Example of Configuration

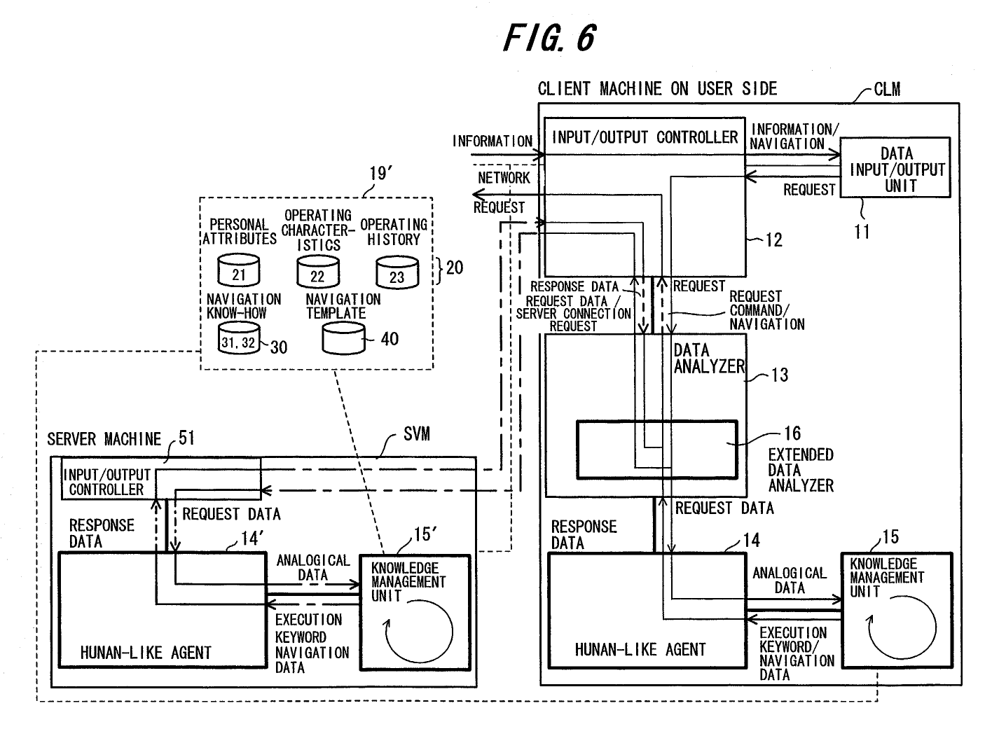

FIG. 6 illustrates a third example of a configuration in which the functions and data of the human-like agent and knowledge management unit are distributed between the user's client machine CLM and the server machine SVM. Here the extended data analyzer 16 of data analyzer 13 performs communication between the human-like agent 14 on the side of the client machine CLM and the human-like agent 14′ on the side of the server machine SVM.

In a case where an execution keyword can be acquired on the side of the client machine CLM and response data can be generated using this execution keyword, the abbreviated operation of the third example of configuration is exactly the same as that [steps (101) to (113)] of the first example.

In a case where an execution keyword cannot be acquired on the side of the client machine CLM and response data cannot be generated using this execution keyword, on the other hand, the abbreviated operation of the third example of configuration is as follows:

(301) First, the abbreviated operation [(101) to (106)] of the first example is executed.

(302) If an execution keyword cannot be extracted at step (106), then the human-like agent 14 delivers the request data and the request for connection to the server machine SVM to the extended data analyzer 16.

(303) The abbreviated operation of steps (205) to (217) of the second example of configuration is executed.

The foregoing is for a case where, if creation of the response data turns out to be impossible after an initial attempt is made to acquire an execution keyword and create the response data on the side of the client machine CLM, the client side requests the side of the server machine SVM to acquire the execution keyword and create the response data. However, the converse is possible as well. That is, if creation of the response data turns out to be impossible after an initial attempt is made to acquire an execution keyword and create the response data on the side of the server machine SVM, then the side of the server machine SVM requests the side of the client machine CLM to acquire the execution keyword and create the response data.

In this instance, the abbreviated operation of the third example of configuration, in which the execution keyword can be acquired on the side of the server machine SVM and the response data can be generated using this execution keyword, would be exactly the same [steps (201) to (217)] as that of the second example.

In a case where an execution keyword cannot be acquired on the side of the server machine SVM and response data cannot be generated, the abbreviated operation of the third example of configuration is as follows:

(401) First, the abbreviated operation [(201) to (208)] of the second example is executed.

(402) If an execution keyword cannot be extracted at step (208), then the human-like agent 14′ delivers the request data and the request for connection to the client machine CLM to the input/output controller 51.

(403) The input/output controller 51 delivers the request data to the input/output controller 12 on the side of the client machine in response to the request for connection to the client machine CLM, and the input/output controller 12 delivers the request data to the data analyzer 13. (404) The abbreviated operation [(105 to 113)] of the first example of configuration is then executed.

Thus, the optimum system configuration can readily be constructed on both the side of the service provider and the side of the service user, and the optimum response can be given to the user request.

(d) Link Processing Section

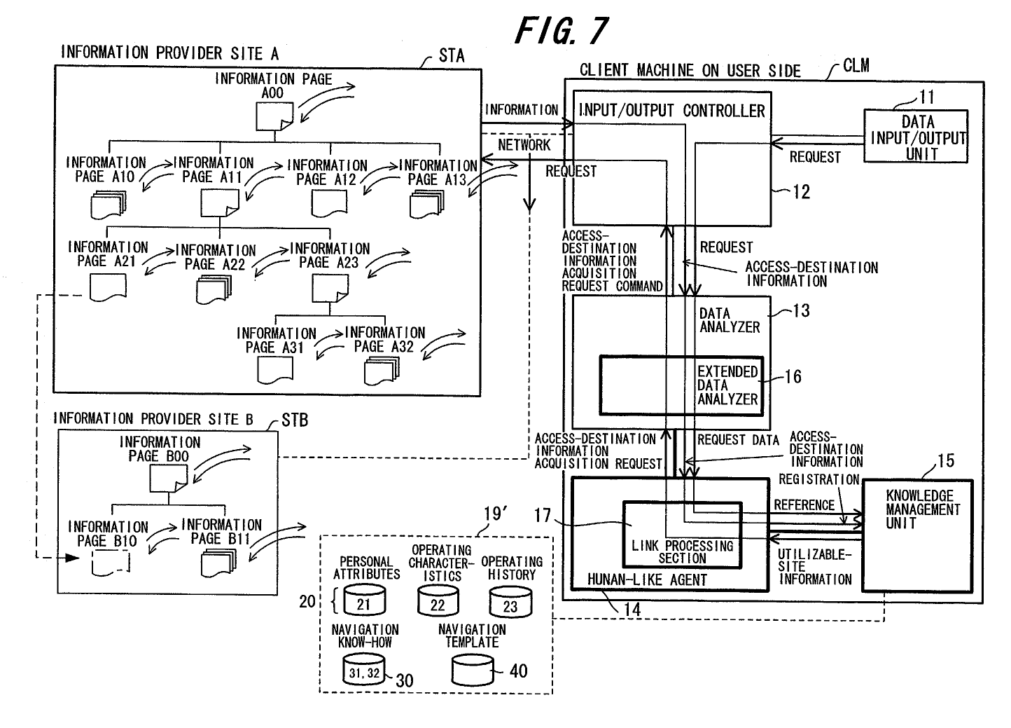

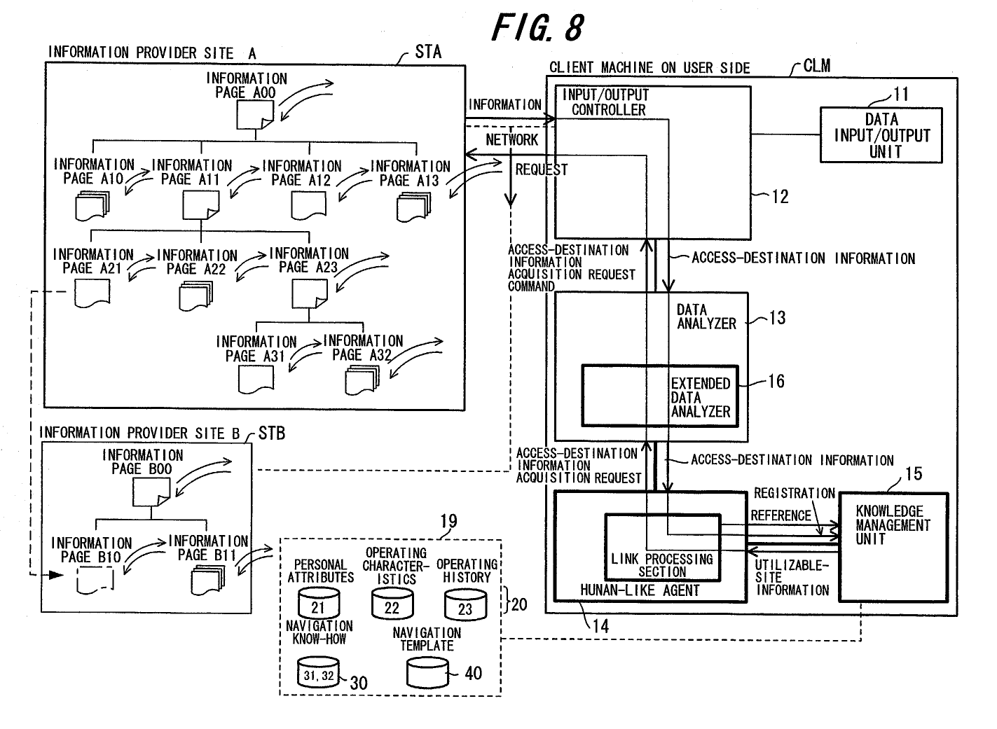

The human-like agent 14 is provided with the link processing section 17, as shown in FIGS. 7 and 8. The link processing section 17 automatically acquires the access-destination information from utilizable-information sites STA, STB on the network whenever the user performs a target-information acquisition operation (FIG. 7), or at a timing specified by the user, or periodically (FIG. 8), and the knowledge management unit 15 updates old access-destination information 31 to the latest access-destination information.

Specifically, the operation is as follows:

(501) When a timing that has been registered in advance arrives (see FIG. 8), the link processing section 17 acquires utilizable-site information from the knowledge management unit 15, creates an access-destination information acquisition request and delivers the request to the data analyzer 13.

(502) The extended data analyzer 16 of data analyzer 13 delivers an access-destination information acquisition command to the input/output controller 12.

(503) The input/output controller 12 acquires access-destination information from the prescribed information provider sites STA, STB via the network in response to the request command and delivers this information to the data analyzer 13.

(504) The extended data analyzer 16 of data analyzer 13 delivers the access-destination information to the human-like agent 14.

(505) The human-like agent 14 delivers the access-destination information to the knowledge management unit 15.

(506) The knowledge management unit 15 updates the access-destination information 31, which has been stored in the knowledge database 19, to the new access-destination information just acquired.

Thus, it is possible to provide the optimum response to a user request based upon knowledge data optimized by the latest information.

For instance, assume that an example of HTML-based markup of an information page A is as follows:

<html>

<head>

<title> trash collection </title>

</head>

<body>

<center>

<H1> trash collection </H1>

1. <a href=“A.html”> trash collection for district A </a> (1)

2. <a href=“B.html”> trash collection for district B</a> (2)

</center>

<a href=“Top html”>return to top page </a> (3)

</body>

</html>

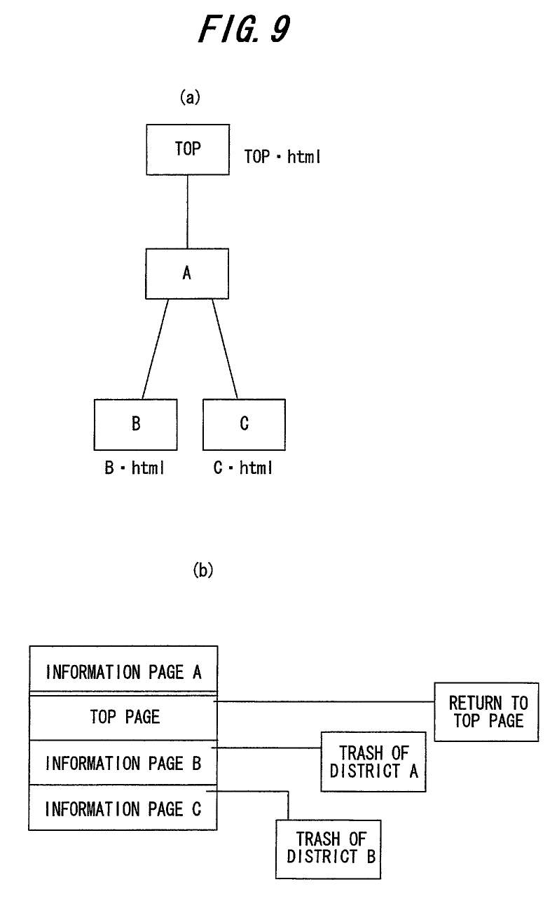

In the above HTML-based markup, <href> signifies an anchor, and (1), (2) and (3) mean jump to information page B, jump to information page C and return to the top page TOP, respectively. Further, the English text bracketed by <a> and </a> is a keyword. Accordingly, hierarchical structure information of information pages indicated at (a) in FIG. 9 and keywords indicated at (b) in FIG. 9 are acquired as access-destination information from the information page A.

(e) Media Processing Section

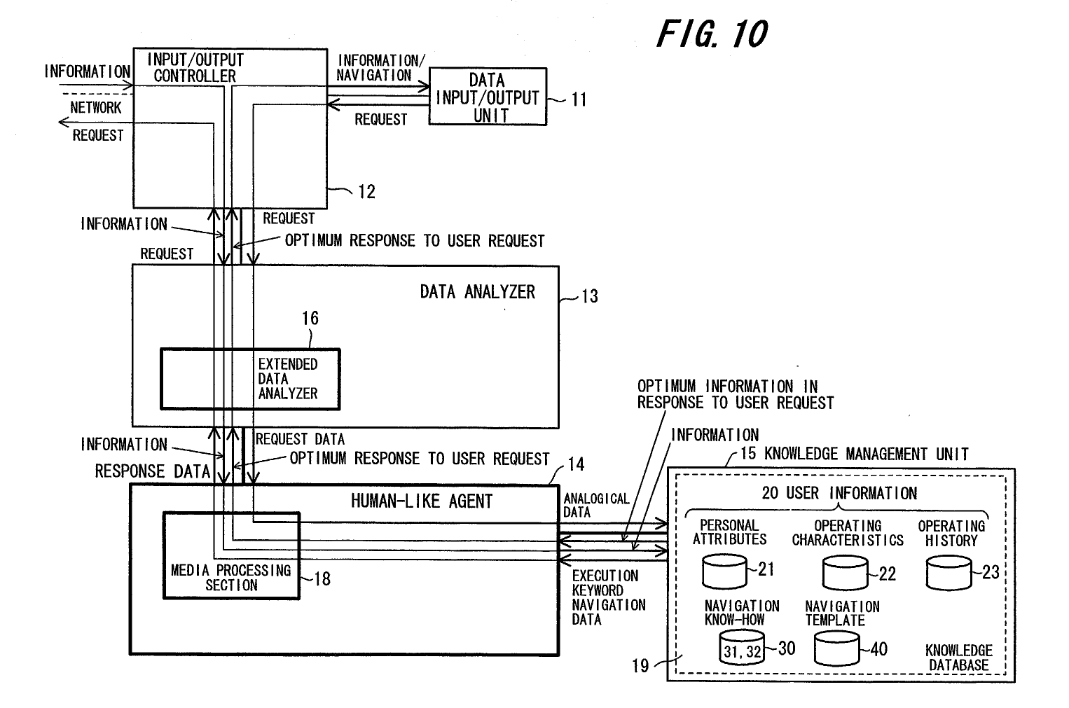

The human-like agent 14 is provided with the media processing section 18, as shown in FIG. 10, and converts and shapes the response data (navigation) from the system into the proper format in accordance with the apparatus employed by the user and the circumstances of the user. The operation of the media processing section 18 is as follows:

(601) The media processing section 18 identifies the client machine CLM employed by the user and acquires an output format in which output is possible.

(602) The media processing section 18 acquires priority-media information from the user information 20, such as the personal attributes of the user, managed by the knowledge management unit 15, and acquires an output format based upon the priority media information. The priority-media information is information that indicates an output format for a voice output or text output or both.

(603) The media processing section 18 decides the proper output format from an output format based upon the user's client machine and the output format based upon the priority-media information, converts and shapes the navigation (guidance message) in accordance with the proper output format, and delivers the results to the input/output unit.

Thus, it is possible to provide the optimum answer to the user request in accordance with the apparatus employed by the user and the circumstances of the user.

(B) Embodiment

(a) Configuration

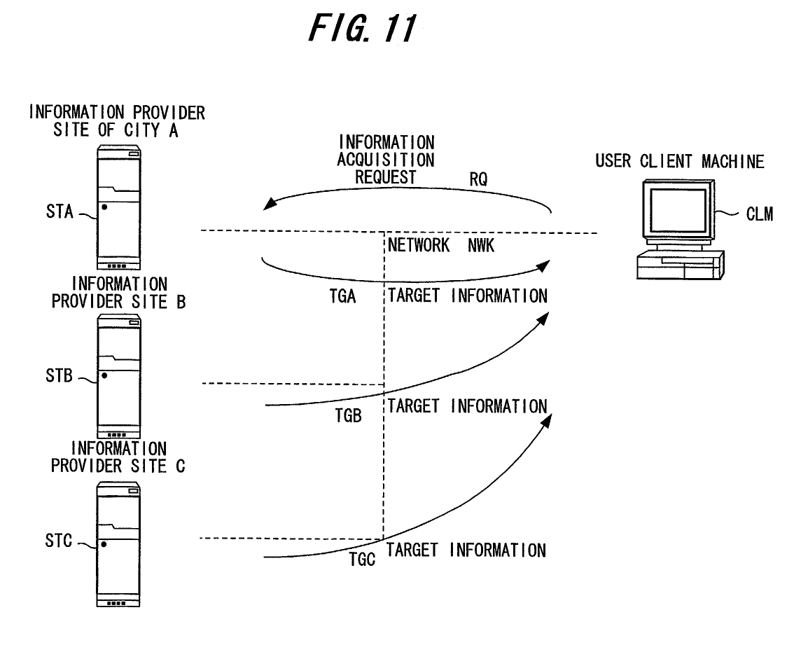

FIG. 11 illustrates the configuration of a system to which the present invention is applied. Here the client machine CLM employed by the user has been connected to information provider sites STA, STB, STC, . . . via the network NWK. The site STA is an information provider side located in City A. The information provider sites STA, STB, STC, . . . publicly disclose information providing pages (Web pages, etc.) having keywords and provide prescribed target information TGA, TGB, TGC, respectively, in accordance with an information provision request RQ from the client machine CLM.

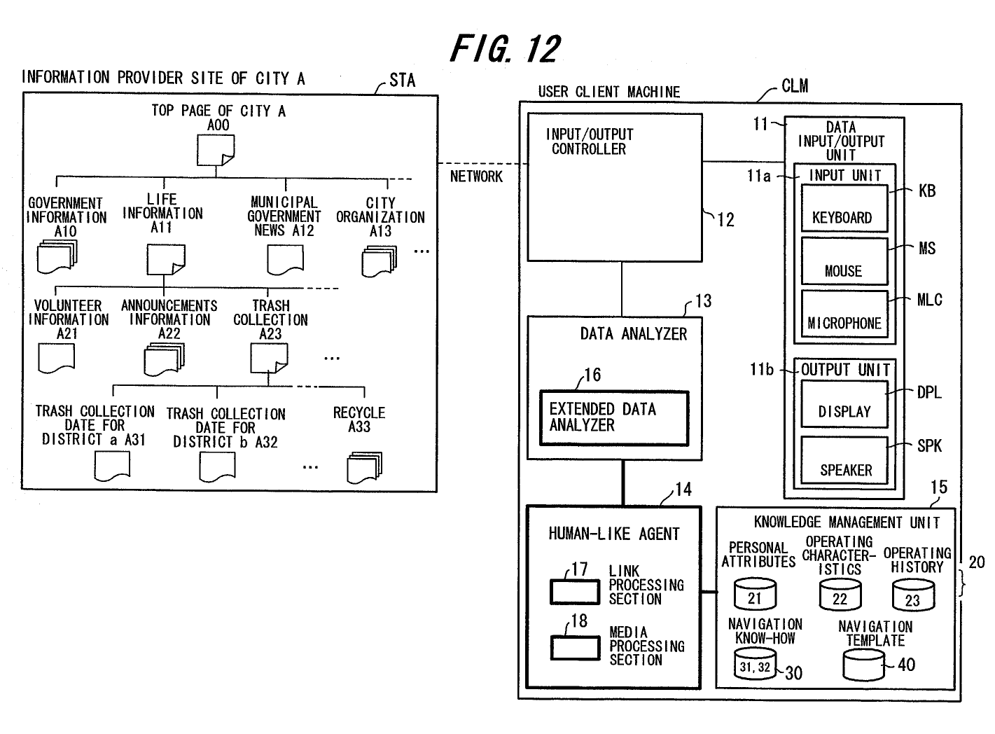

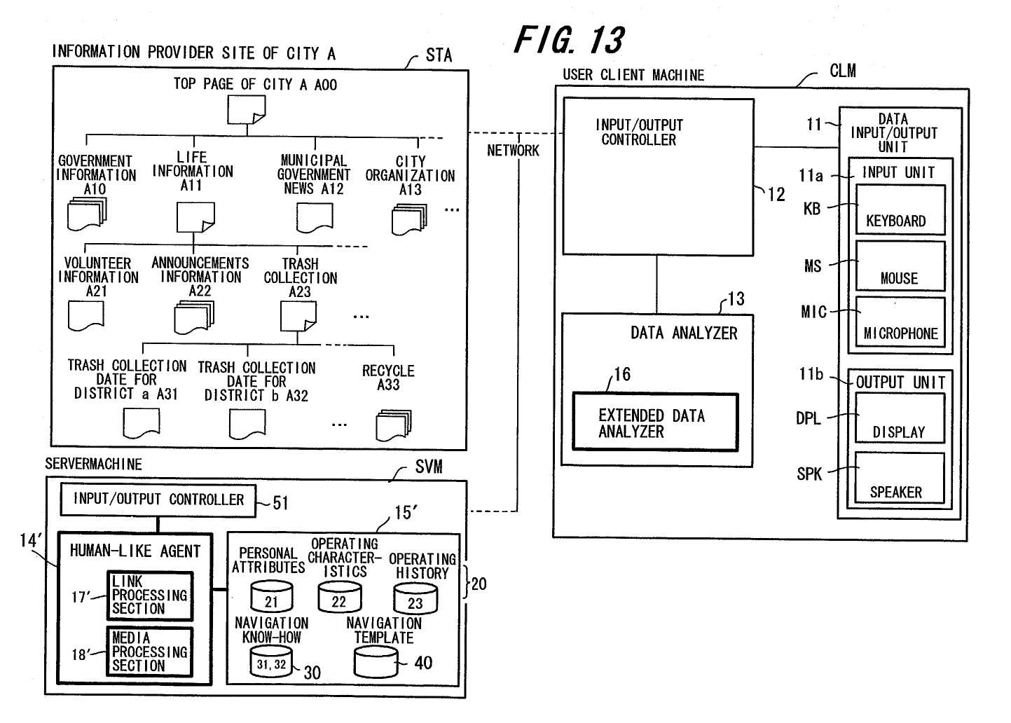

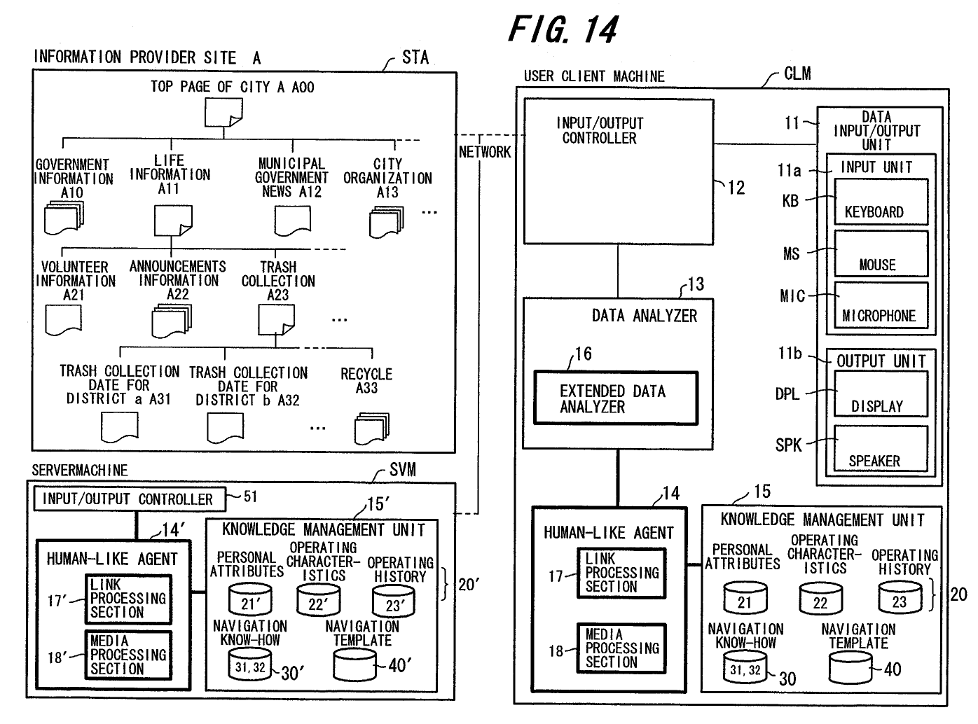

FIG. 12 is a block diagram illustrating an interactive Web browsing system for a case where all units are incorporated in the user's client machine CLM, FIG. 13 is a block diagram illustrating an interactive Web browsing system for a case where the human-like agent 14′ and knowledge management unit 15′ are incorporated in the server machine SVM, which is separate from the user's client machine CLM, and FIG. 14 is a block diagram illustrating an interactive Web browsing system for a case where the functions and data of the human-like agent and knowledge management unit are distributed dynamically between the user's client machine CLM and a server machine SVM. Components in FIGS. 12 to 14 identical with those shown in FIGS. 1 to 10 are designated by like reference characters. The differences are that the structure of the data input/output unit 11 is clearly shown and that the hierarchy of information pages at the information provider site STA of City A is clearly shown.

The data input/output unit 11 has an input unit 11a and an output unit 11b. A keyboard KB, mouse MS and microphone MIC are provided as the input unit 11a, and a display (monitor) DPL and speaker SPK are provided as the output unit 11b. Also provided at suitable locations are a voice recognition engine, which recognizes voice that has entered from the microphone MIC, and a voice synthesizing engine for generating voice data, which represents target information and navigation, output from the speaker.

As illustrated in these drawings, the hierarchy of the information pages at the information provider site STA of City A is such that the pages of a first layer, namely a government information page A10, life information page A11, municipal government news page A12 and city organization page A13, . . . , are linked to a City A top page A00. Further, pages of a second layer, namely a volunteer information page A21, announcements information page A22, trash collection page A23, . . . , are linked to a page of the first layer, e.g., the life information page A11. Furthermore, pages of a third layer, namely a page A31 relating to trash collection date for District a, a page A32 relating to trash collection date for District a, . . . , a recycle page A33 are linked to the trash collection page A23. Furthermore, if necessary, pages of a fourth layer are linked to pages of the third layer.

(b) Knowledge Information

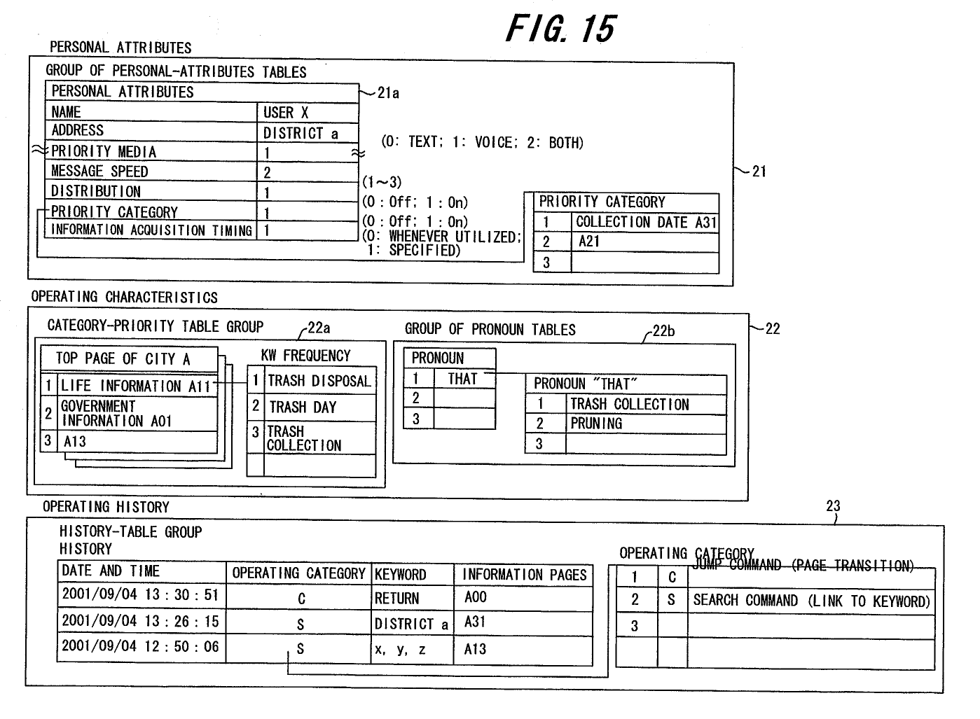

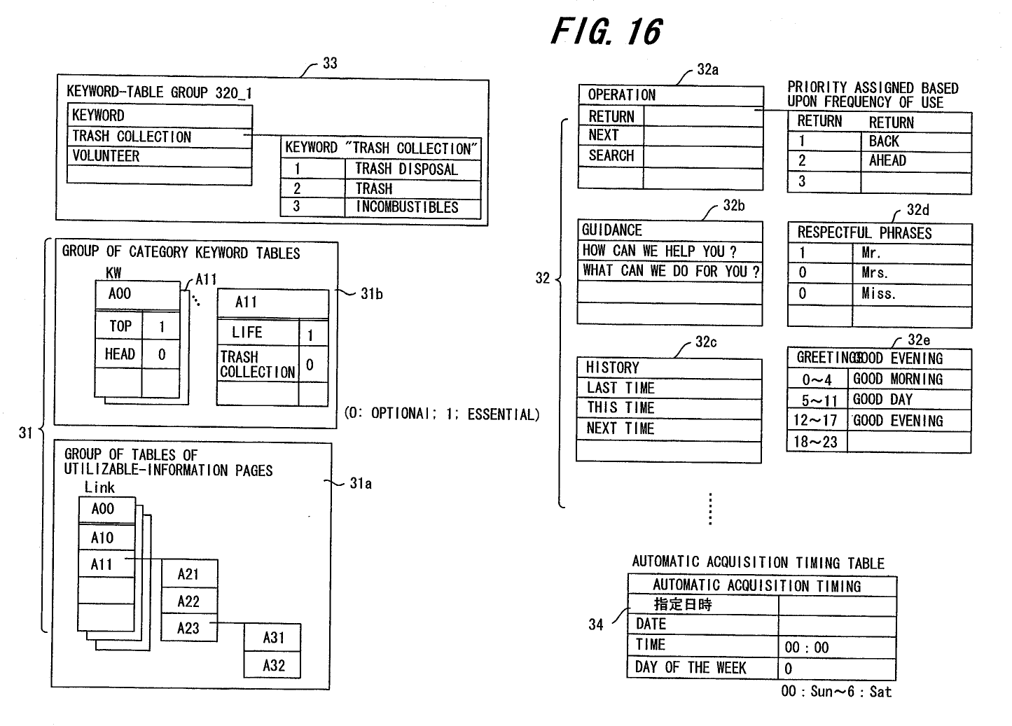

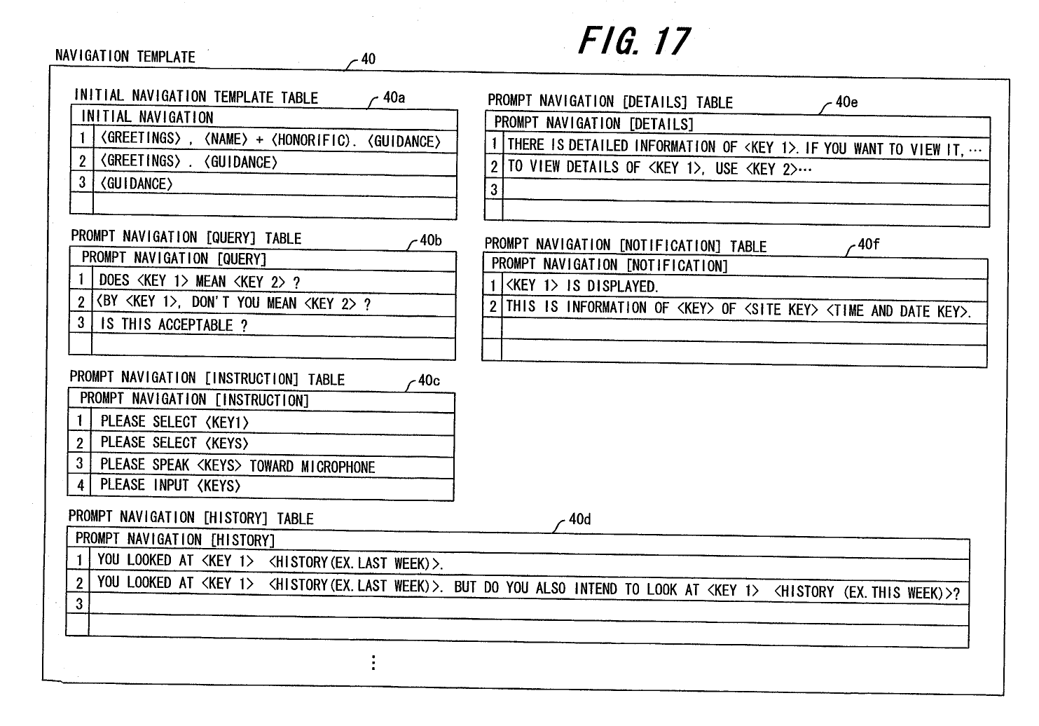

FIGS. 15 and 17 illustrate examples of the structure of knowledge information managed by the knowledge management unit 15, in which FIG. 15 shows an example user information, FIG. 16 an example of navigation know-how information and FIG. 17 and example of a navigation template.

(b-1) User Information

The user information 20 includes the personal attributes information 21, operating characteristics information 22 and operating history information 23. The personal attributes information 21 is information that indicates the personal attributes of the user and is registered before the interactive browsing system is utilized. This information can be changed as necessary and is updated automatically by being utilized. Included as the personal attributes information 21 are \mathring{1} the user's name, \mathring{2} address, \mathring{3} priority-media information specifying the output format, \mathring{4} message speed specifying the output speed of messages, \mathring{5} distribution information specifying whether the browsing system has a distributed configuration, \mathring{6} priority-category information indicating the order of priority of information pages the user desires, and \mathring{7} information-acquisition timing information indicating the timing at which access-destination information is acquired.

The operating characteristics information 22 indicates the user's operating traits (e.g., how the user applies keywords used when acquiring data, the frequency of use of these keywords, etc.). This information is updated automatically by being utilized. The operating characteristics information 22 has a category-priority table group 22a of priority tables classified by category, and a group 22b of pronoun tables.

There are instances where a transition is made from a certain information page (category) to another information table. The category-priority table group 22a lists, in order of decreasing frequency of transition, the information pages to which the transition has been made. In FIG. 15, the information pages to which the transition has been made (the life information page A11, government information page A10 and city organization page A13) in the City A top page A00 are indicated in order of frequency, and the keywords (“trash disposal”, “disposal date”, “trash collection”) used when the transition is made to the life information page are indicated in order of frequency.

The group 22b of pronoun tables indicates, in order of frequency, pronouns used when the user acquired target information as well as the nouns for which these pronouns have been substituted. Which noun a pronoun represents can be recognized based upon navigation, which is output in the course of execution-keyword acquisition, and responses to this navigation. In FIG. 15, the pronoun “that” represents “trash collection” and “pruning”.

The operating history information 23 indicates operating history such as when and what operations were performed by the user and what keywords were used when the user acquired target information. This information can be deleted any time starting with the older information.

(b-2) Navigation Know-How Information

The navigation know-how information 30 includes the access-destination information 31, dictionary information 32, a keyword-table group 33 and an automatic-acquisition timing table 34.

The access-destination information 31 has a group 31a of tables of utilizable-information pages, which indicate the hierarchical structure of information pages at utilizable information provider sites, and a group 31b of category/keyword tables which store keywords used in order to make a transition to each information page. Keywords includes essential keywords and optional keywords. In the table group 31b, keywords of the top page A00 are two in number, namely “top” and “head”. The former indicates an example of an essential keyword and the latter an example of an optional keyword. Further, keywords of the life information page A11 are “life” and “trash collection”, of which the former is an example of an essential keyword and the latter an example of an optional keyword.

The dictionary information 32 is a dictionary of phrases necessary for interaction with the user in operating guidance. A variety of phrases are registered in this dictionary. In FIG. 16, the following phrases have been registered: operating phrases (“return”, “next”, “search”) 32a used in indicating operation, guiding phrases 32b, historical phrases (“last time”, “this time”, “next time”, etc.) 32c, respectful phrases 32d and greetings terminology 32e, which depends upon the time of day.

The keyword-table group 33, which is updated automatically, indicates correspondence between keywords and phrases used in the same sense as the keywords. The automatic-acquisition timing table 34 specifies the timing (date and time) at which access-destination information is acquired.

(b-3) Navigation Template

The navigation template 40 is a model of navigation (guidance messages) such as operating guidance presented to the user. Additions and changes can be made to the template, and portions can be deleted. The navigation template is prepared in accordance with use. The navigation template 40 has an initial navigation template 40a, a querying prompt navigation template 40b, an instructing prompt navigation template 40c, a historical prompt navigation template 40d, a detailed prompt navigation template 40e, and a notification prompt navigation template 40f. Navigation is generated by fitting phrases and user name, etc., which have been registered in the dictionary 32, into the <KEY> section of each template.

(c) Processing

Various processing will now be described with reference to the arrangement (FIG. 12) in which all units of the interactive browsing system are incorporated in the client machine CLM.

(c-1) Processing for Registering Access Destination Information

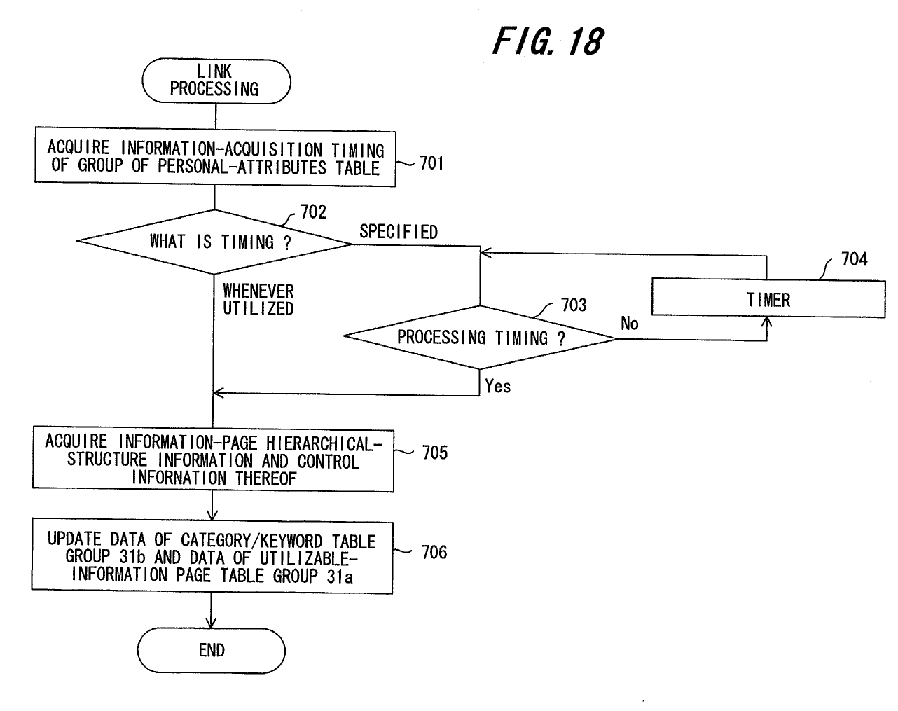

FIG. 18 is a flowchart of processing for registering access-destination information.

The link processing section 17 of the human-like agent 14 acquires information-acquisition timing data from the personal attributes information 21 managed by the knowledge management unit 15 (step 701) and determines whether this data is “0” or “1” (step 702).

If the information-acquisition timing data is logical “1”, i.e., if the fact that access-destination information of information provider site STA of City A is to be acquired at a designated time has been specified, the link processing section 17 detects timing information (“every Sunday and 00:00”) from the automatic-acquisition timing table 34 managed by the knowledge management unit 15. Next, the link processing section 17 determines whether the present time is the designated time (step 703). If the answer is “NO”, then the link processing section 17 measures time and waits for the designated time to arrive (step 704).

When the designated time arrives, the link processing section 17 creates a request for acquisition of access-destination information and delivers this request to the data analyzer 13. The extended data analyzer 16 of data analyzer 13 creates a request command in accordance with the request for acquisition of access-destination information and delivers this command to the input/output controller 12. The latter acquires access-destination information from the information provider site STA of City A via the network in response to this request command and delivers the access-destination information to the data analyzer 13. The extended data analyzer 16 of data analyzer 13 delivers this access-destination information to the human-like agent 14 (step 705).

The human-like agent 14 delivers the acquired access-destination information to the knowledge management unit 15. In response, the knowledge management unit 15 analyzes the keyword information, link information and other control information contained in the access-destination information and updates, to the latest information, the group 31a of tables of utilizable-information pages and the group 31b of category/keyword tables shown in FIG. 16.

If it is found at step 702 that the information-acquisition timing data is “0”, then the processing from step 705 onward is executed whenever the user utilizes the browsing system to acquire target information.

Thus, the optimum network service can be provided in response to a user request based upon knowledge data that has been optimized by the latest information.

(c-2) Processing for Registering Knowledge Information

Registration of User Information Such as Personal Attributes of User, Operating Characteristics and Operating Calendar

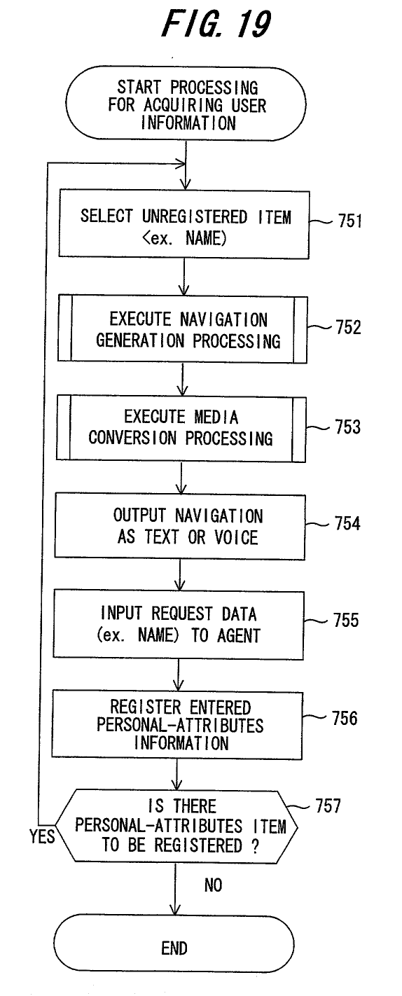

The human-like agent 14 executes user-information registration processing when the browsing system is initially launched or when there is a request from the user to register/change the user information. FIG. 19 is a flowchart of processing for registering user information.

When start of processing for registering user information is directed, the human-like agent 14 extracts an unregistered item (e.g., the input keyword “name”) in the personal attributes information 21 of knowledge management unit 15 (step 751).

Next, the human-like agent 14 executes a processing routine for generating navigation data and combines the input keyword “name” and an already registered prescribed navigation template to generate the navigation “PLEASE ENTER YOUR NAME” (step 752).

The media processing section 18 of human-like agent 14 thenceforth decides the output format in accordance with a media-conversion processing routine, converts the navigation data “PLEASE ENTER YOUR NAME” to voice data or text data in compliance with the output format, and delivers this data, together with the input keyword “name”, to the data analyzer 13 as response data (step 753).

The extended data analyzer 16 of the data analyzer 13 extracts the input keyword and navigation from the entered response data and delivers these to the input/output controller 12. By virtue of the above operations, the data input/output unit 11 displays the navigation “PLEASE ENTER YOUR NAME” as text on the display unit DPL or outputs this navigation from the speaker as voice (step 754).

Using the microphone MIC of the data input/output unit 11, the user enters the user name “USER X” that has been requested by the navigation by, e.g., voice. The voice data is input to the data analyzer 13 via the input/output controller 12. The extended data analyzer 16 of the data analyzer 13 recognizes and analyzes the voice data by the internal voice recognition engine, converts the voice data to text data that can be processed within the system and delivers the text data to the human-like agent 14 (step 755).

The human-like agent 14 delivers the name data “USER X” to the knowledge management unit 15, and the latter registers the name of the user at the applicable item of the personal attributes information 21 (step 756).

The human-like agent 14 thenceforth determines whether an item to be registered remains in the personal attributes information 21 managed by the knowledge management unit 15 (step 757). If such an item remains, the human-like agent 14 repeats the processing of step 751 onward with regard to this item.

It should be noted that the dictionary 32 of phrases necessary for interaction with the user and the navigation template 40 have already been registered in the client machine.

(c-2) Processing for Generating Navigation

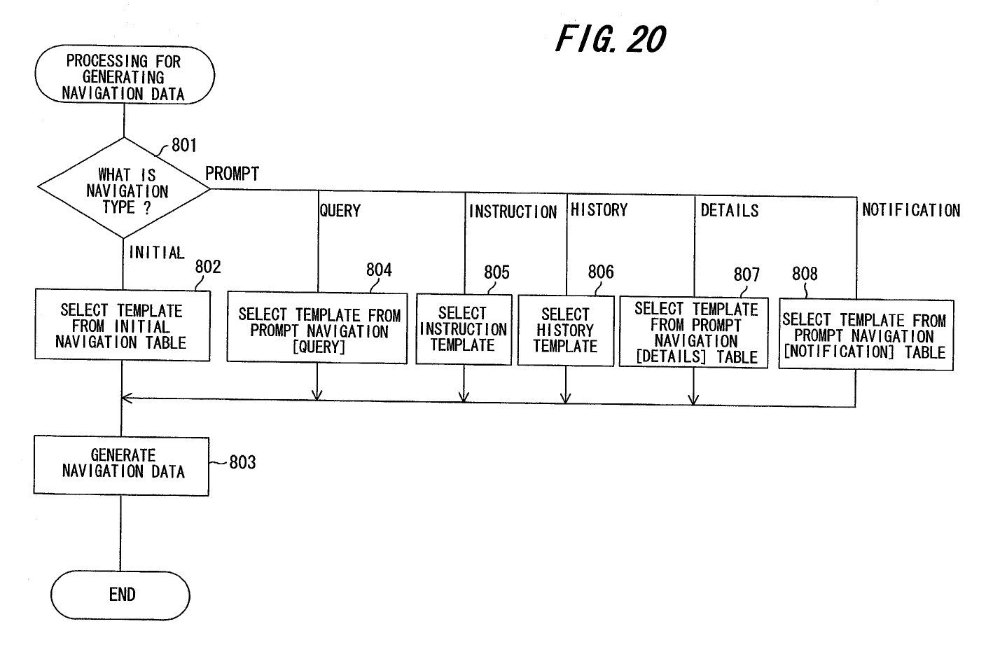

FIG. 20 is a flowchart of processing for generating navigation.

When it becomes necessary to generate navigation, the human-like agent 14 decides the type of navigation (step 801). More specifically, the human-like agent 14 decides whether the circumstances call for creation of navigation using the initial navigation template or for creation of navigation using the prompt navigation template.

If the circumstances call for creation of navigation using the initial navigation template, the human-like agent 14 selects a template conforming to these circumstances from the initial navigation template 40a (step 802) and selects suitable words, which have been fitted into the <KEY> section of this template, from the dictionary 32 to thereby generate navigation (step 803).

If it is found at step 801 that the circumstances call for creation of navigation using the prompt navigation template, on the other hand, a prescribed template is selected (steps 804 to 808) from among the templates 40b to 40f depending upon whether the circumstances \mathring{1} call for the user to be queried, \mathring{2} call for the user to be instructed, \mathring{3} call for history to be indicated to the user, \mathring{4} call for the existence of detailed information to be indicated to the user, and \mathring{5} call for the content of output information to be reported to the user. Thereafter, the appropriate words that have been fitted into the <KEY> section of the above template are selected from the dictionary 32, etc., to thereby generate navigation (step 803).

(c-4) Media Conversion Processing

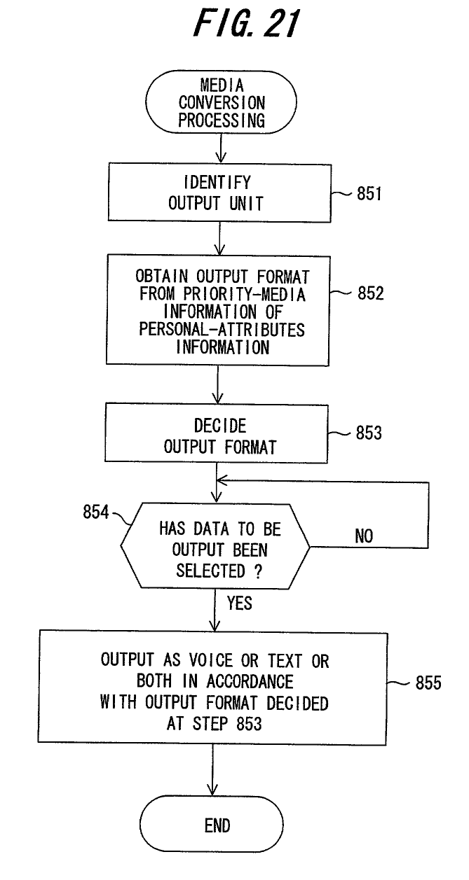

FIG. 21 is a flowchart of processing for converting media.

The media processing section 18 of human-like agent 14 identifies beforehand the type (display unit DPL, speaker SPK) of output unit employed by the user and acquires an output format in which an output can be made (step 851). Next, the media processing section 18 acquires priority-media information from the user's personal attributes information 21 managed by the knowledge management unit 15 and obtains an output format based upon the priority-media information. The priority-media information is information indicating an output format such voice output or text output or both.

Next, the media processing section 18 decides the proper output format (step 853) from the output format based upon user's client machine and the output format based upon the priority-media information.

The media processing section 18 thenceforth performs monitoring to determine whether navigation (a guidance message) has been input (step 854). If the decision rendered is “YES”, then the media processing section 18 converts and shapes the navigation data in accordance with whether the output format that was decided at step 853 is that of a voice output or a text output or both, and outputs the results from the output unit 11b (step 855).

(c-5) Processing for Acquiring Target Information

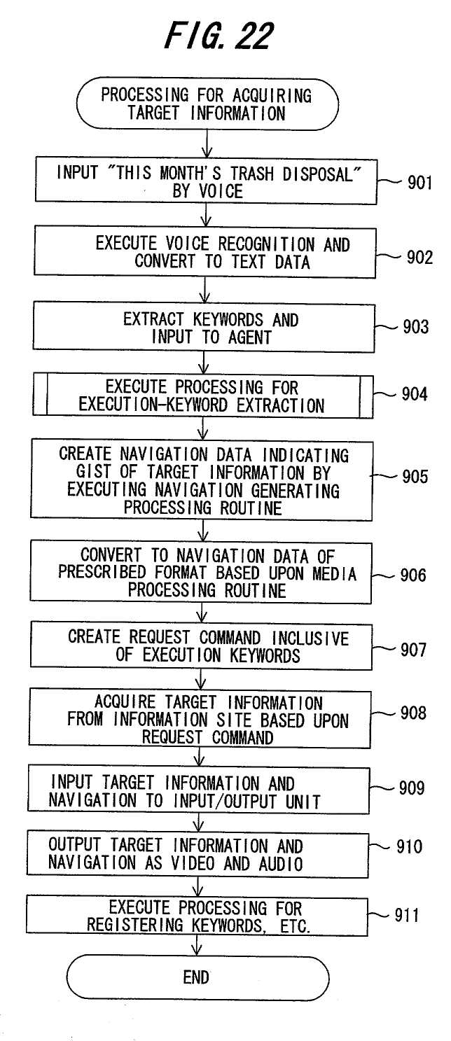

FIG. 22 is a flowchart of processing for acquiring target information in the arrangement (FIG. 12) in which the interactive browsing system is incorporated within the client machine CLM. This will be described taking as an example a case where the user acquires information relating to “THIS MONTH'S TRASH-COLLECTION DATES FOR DISTRICT a” as target information from information provider site STA of City A.

The user inputs “THIS MONTH'S TRASH DISPOSAL” by voice using the microphone MIC of the data input/output unit 11 (step 901).

The data input/output unit 11 inputs voice data “THIS MONTH'S TRASH DISPOSAL” to the data analyzer 13 via the input/output controller 12. The extended data analyzer 16 of data analyzer 13 recognizes and analyzes the voice data that is input by the voice recognition engine and converts this voice data to text data capable of being processed within the system (step 902). The extended data analyzer 16 then extracts, as keywords from the text data, parts of speech that match specified parts of speech. In other words, the extended data analyzer 16 extracts “THIS MONTH” and “TRASH DISPOSAL” as keywords and adopts these as request data (step 903).

Next, the extended data analyzer 16 inputs the extracted “THIS MONTH” and “TRASH DISPOSAL” to the human-like agent 14. The latter, by executing a processing subroutine for execution-keyword extraction, recognizes “TRASH DISPOSAL” as “TRASH COLLECTION” from the keyword-table group 33 (see FIG. 16) managed by the knowledge management unit 15. Since a location request has not been received in this case, the address “DISTRICT a” is extracted from the personal attributes information 21 (FIG. 15). Next, “COLLECTION DATE” is selected from among the priority-category items of personal attributes information 21 and the execution keywords “THIS MONTH”, “TRASH COLLECTION”, “DISTRICT a”, “COLLECTION DATE” are extracted (step 904). If an execution keyword cannot be determined, the human-like agent 14 analyzes additional other information managed by the knowledge management unit 15, selects a candidate, generates navigation and decides on a keyword in conformity with the user request by interacting with the user. Further, it is possible to extract an execution keyword, even if a perfect match is not achieved, by a so-called fuzzy search.

From the execution keywords “THIS MONTH”, “TRASH COLLECTION”, “DISTRICT a” and “COLLECTION DATE”, the human-like agent 14 generates the navigation “THIS MONTH'S TRASH-COLLECTION DATE INFORMATION FOR DISTRICT a. ANY MORE INFORMATION?”, which is for notifying the user of the gist of the target information, by executing a processing routine for generating navigation.

The media processing section 18 of human-like agent 14 converts the navigation to a text-data format or voice-data format or both based upon the media processing routine of FIG. 21 (step 906).

Next, the human-like agent 14 creates response data obtained by combining the execution keywords and navigation data and delivers this data to the data analyzer 13. The extended data analyzer 16 of data analyzer 13 extracts the execution keywords (“THIS MONTH”, “TRASH COLLECTION”, “DISTRICT a”, “COLLECTION DATE”) and the navigation data from the entered response data and generates a request command that contains the execution keywords (step 907).

The extended data analyzer 16 inputs the request command and the navigation to the input/output controller 12, and the latter acquires the target information “A31: TRASH COLLECTION DATE FOR DISTRICT a” from the information provider site STA of City A via the network in response to the request command (step 908). The extended data analyzer 16 inputs this target information and navigation to the data input/output unit 11 (step 909).

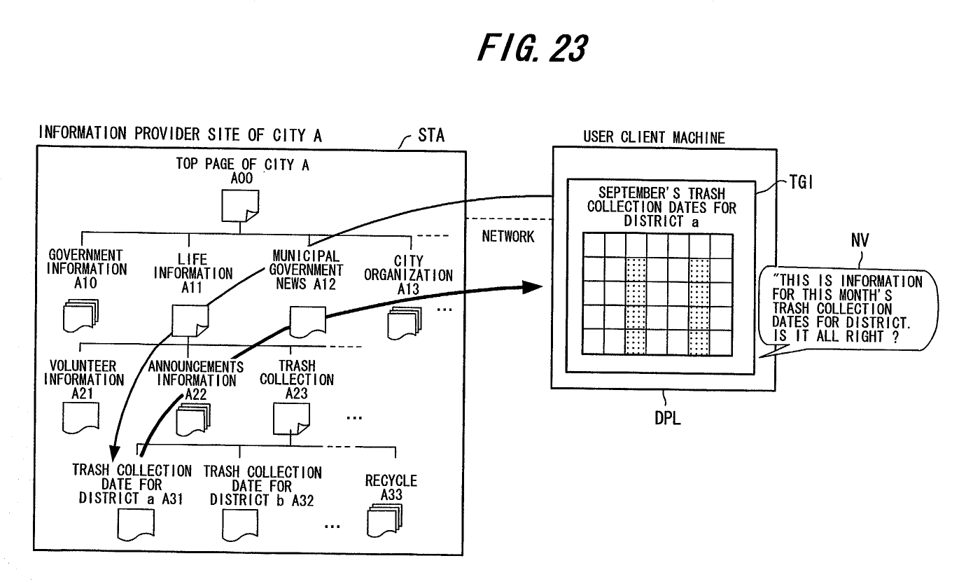

In order that the user may obtain this information and navigation, the data input/output unit 11 outputs the target information “TRASH COLLECTION DATE FOR DISTRICT a” TGI and the navigation “THIS MONTH'S TRASHCOLLECTION DATE INFORMATION FOR DISTRICT a. ANY MORE INFORMATION?” NV to the display unit DPL and speaker SPK in a form in which the video and the audio are operatively associated (step 910). For example, the target information TGI is displayed on the display unit DPL and the navigation NV is output as voice, as shown in FIG. 23.

Next, if the user makes an entry to the effect that the information search is to end or requests access to the top page of another information site, the knowledge management unit 15 registers or updates the content of this series of operations thus far (information such as the keywords that have been entered by interaction between the user and the system, the extracted keywords and the information pages output in accordance with these keywords) in the personal attributes information 21, the category-priority table group 22a, the group 22b of pronoun tables and the operating history information 23 (step 911).

(c-6) Processing for Extracting Execution Keywords

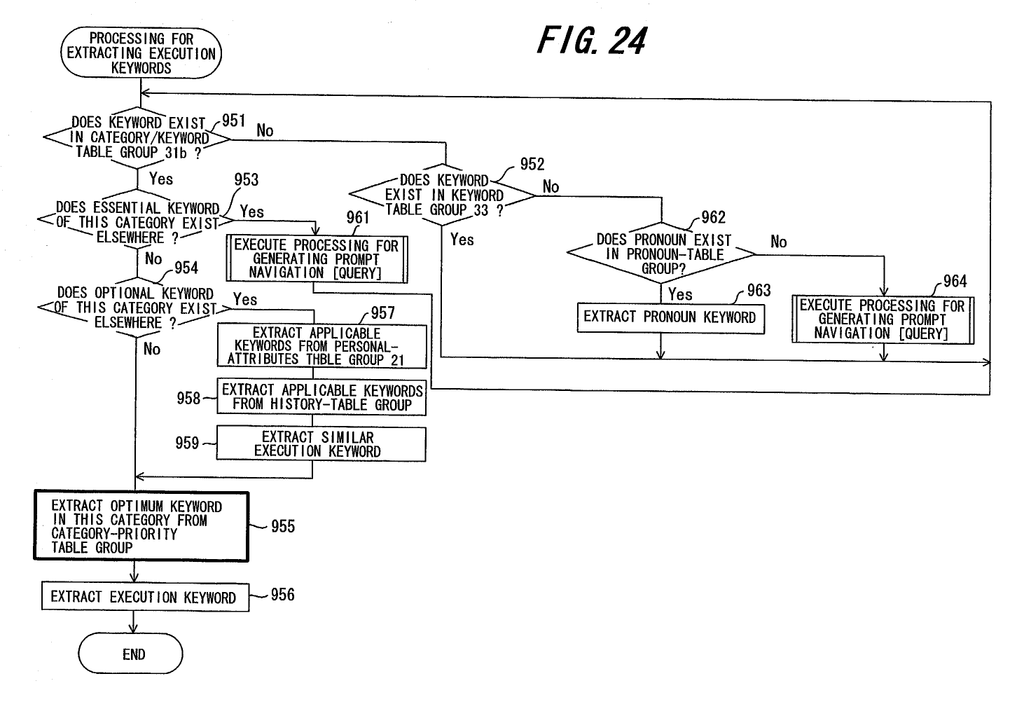

FIG. 24 is a flowchart of processing for extracting execution keywords.

Assume that the top page of the information provider site STA of City A has a voice input and that “TRASH DAY” has been extracted as the keyword at step 903 in FIG. 22.

The human-like agent 14 refers to the group 31b of category/keyword tables to determine whether “TRASH DAY” exists in this group of tables (step 951). If it does not exist, then the human-like agent 14 checks the keyword-table group 33 to determine whether a keyword having the same meaning as “TRASH DAY” exists there (step 952). If a keyword that is synonymous with “TRASH DAY” exists, then the human-like agent 14 executes the processing of step 951 using this keyword. In the drawings, the keyword “TRASH COLLECTION”, which is synonymous with “TRASH DAY”, exists in the keyword-table group 33, and the keyword “TRASH COLLECTION” exists in category A11 (life information A11) of the group 31b of category/keyword tables.

Thereafter, the human-like agent 14 obtains the essential keyword of category A11 (life information A11) and refers to the group 31b of category/keyword tables to determine whether the essential keyword “LIFE” exists in another category (step 953). If the essential keyword “LIFE” does not exist in another category, then the human-like agent 14 obtains an optional keyword “TRASH COLLECTION” of category A11 (life information A11) and refers to the group 31b of category/keyword tables to determine whether the optional keyword “TRASH COLLECTION” exists in another category (step 954).

If the optional keyword “TRASH COLLECTION” does not exit in another category, then the human-like agent 14 refers to the category-priority table group 22a, obtains the keyword “TRASH DISPOSAL” (step 955) used most often when a transition is made from the top page A00 to the category A11 (life information A11), and adopts this keyword “TRASH DISPOSAL” as the execution keyword (step 956).

If it is found at step 954 that the optional keyword “TRASH COLLECTION” exists in another category, then the human-like agent 14 extracts keywords relating to “TRASH COLLECTION”, e.g., “DISTRICT a” of the address section and “COLLECTION DATE” of the priority category section, from the personal attributes information 21 as the keywords (step 957). Next, the human-like agent 14 extracts keywords relating to “TRASH COLLECTION”, e.g., “DISTRICT a”, from the operating history information 23 as the keywords (step 958). It should be noted that “DISTRICT a” has already been extracted at step 957. Next, if there is a keyword that resembles “TRASH COLLECTION”, it is extracted (step 959) and processing from step 955 onward is executed.

If it is found at step 953 that an essential keyword exists in another category (information page), then it is necessary to specify a category (information page). Accordingly, the human-like agent 14 executes a processing routine for generating querying prompt navigation, this navigation is generated and is output as voice or text. On the basis of the user's reply to this query, the category (information page) is decided (step 961) and then the processing form step 951 onward is executed.

If “NO” decisions are rendered at both steps 951 and 952, then the keyword is regarded as a pronoun and it is determined whether this pronoun exists in the group 22b of pronoun tables (step 962). If the keyword exists in these tables, then the first candidate “TRASH COLLECTION” for which this keyword (assumed to be “THAT”) is most often substituted is extracted (step 963) and the processing from step 951 onward is repeated. If “NO” decisions are rendered at steps 951 and 952 even with regard to the first candidate, then the second candidate “PRUNING” is extracted (step 963) and the processing from step 951 onward is repeated.

If the keyword does not exist in the group 22b of pronoun tables, or even if it does exist but a keyword for which a “YES” decision will be obtained at step 951 does not exist, the processing routine for generating querying prompt navigation is executed, this navigation is generated and is output as voice or text. A keyword is then extracted (step 964) based upon the user's reply to the query and then processing from step 951 onward is executed. For example, if the keyword is the pronoun “THAT”, the querying prompt navigation will be “WHAT IS ‘THAT’?”

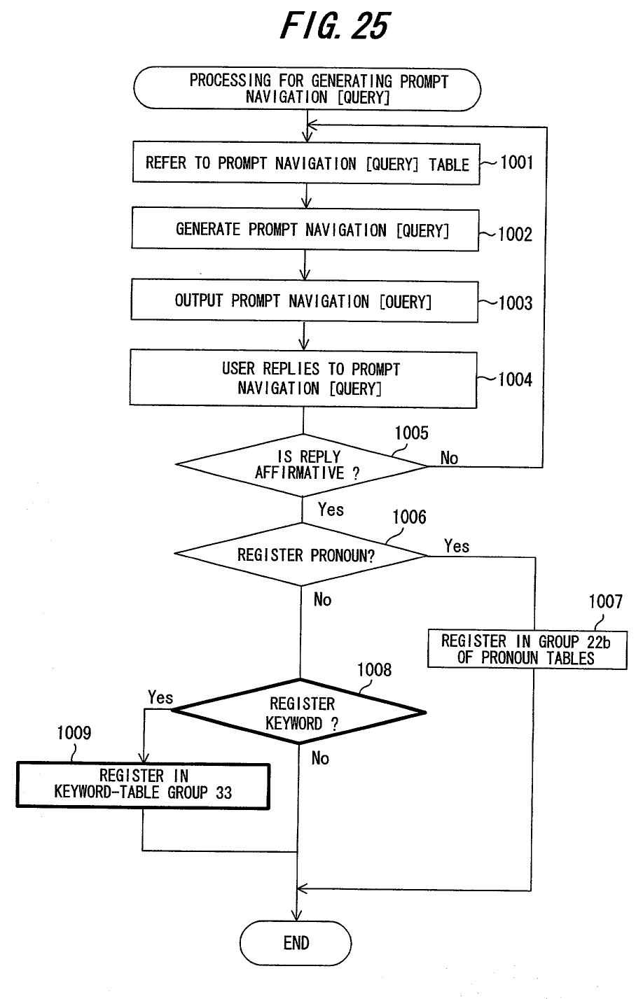

FIG. 25 shows the routine for generating querying prompt navigation.

If the routine for generating querying prompt navigation is initiated at step 961 or 964 in FIG. 24, referring the querying prompt navigation template 40b (FIG. 17) (step 1001), querying prompt navigation conforming to the circumstances is generated (step 1002) and this querying prompt navigation is output (step 1003). If there is a reply from the user in response to this query (step 1004), then it is determined whether the reply is affirmative or negative (step 1005). If the reply is negative, control returns to step 1001 and different routine querying prompt navigation is generated.

If it is found at step 1005 that the user's reply is positive, on the other hand, it is determined whether it is necessary to register a pronoun (step 1006). If registration is necessary, then the pronoun is registered in the group 22b of pronoun tables (step 1007) and processing for generating the query navigation is terminated. If pronoun registration is not necessary, then it is determined whether keyword registration is necessary (step 1008). If keyword registration is not necessary, then processing for generating the query navigation is terminated. If keyword registration is necessary, then the keyword is registered in the keyword-table group 33 (step 1009) and processing for generating the query navigation is terminated. It should be noted that registration and updating is executed by the knowledge management unit 15.

Thus, target information can be acquired directly without requiring that the user be made aware of the sites at which various information pages exist, link information to these information pages and the hierarchical structure thereof and without the user performing a repetitive operation. Further, navigation conforming to the apparatus used by the user and the circumstances of the user can be generated dynamically and the user is guided until the target information is acquired, thereby making it possible to obtain the optimum answer to the user request. As a result, even individuals who are not accustomed to personal computers and network services and individuals who are challenged by the use thereof, especially the elderly, can be provided with network services by an easy-to-use man-machine interface.

(c-7) Processing for Acquiring Target Information in System Having Server Machine

The foregoing is processing in the browsing system of FIG. 12 in which all units of the browsing system are incorporated in the client machine. However, substantially the same processing can be executed also in the arrangement of FIG. 13 having the human-like agent and knowledge management unit provided in the server machine, and in the arrangement of FIG. 14 wherein the human-like agent and knowledge management unit are distributed by being provided in both the client machine and server machine.

Processing for Acquiring Target Information in Browsing System of FIG. 13

In the arrangement of FIG. 13 in which the humanlike agent and knowledge management unit are provided in the server machine, the processing up to extraction of the request data “THIS MONTH” and “TRASH DISPOSAL” by the extended data analyzer 16 is the same as that (steps 901 to 903) of FIG. 22.

When the request data “THIS MONTH” and “TRASH DISPOSAL” are obtained by the processing of step 903, the extended data analyzer 16 inputs this request data and a request for connection to the server machine SVM to the input/output controller 12. The latter sends the request data “THIS MONTH” and “TRASH DISPOSAL” to the input/output controller 51 on the side of the server machine in response to the request for connection to the server machine. The input/output controller 51 delivers the request data “THIS MONTH” and “TRASH DISPOSAL” to the human-like agent 14′.

The human-like agent 14′ acquires an execution keyword and generates navigation through processing similar to that of steps 904 to 906 in FIG. 22.

The human-like agent 14′ thenceforth generates response data, which is obtained by combining the execution keyword and navigation, and inputs this response data and a request for connection to the client machine to the input/output controller 51 on the side of the server machine. The input/output controller 51 on the side of the server machine sends the response data to the input/output controller 12 on the side of the client machine in response to the request for connection to the client machine. The input/output controller 12 inputs the received response data to the data analyzer 13.

Thereafter, through processing similar to that of steps 907 to 911 in FIG. 22, target information is acquired and the output unit 11 outputs this target information, together with navigation, as text or voice.

Thus, the functions and data of an interactive browsing system are managed in a unified manner to facilitate maintenance of the system. In addition, regardless of the type of user, it is possible to provide the optimum network service in response to a uniform user request.

Processing for Acquiring target information in Browsing System of FIG. 14

In the arrangement of FIG. 14 wherein the humanlike agent and knowledge management unit are distributed by being provided in both the client machine and server machine, the processing of FIG. 22 for acquiring target information is executed if response data can be generated on the side of the client machine, and the processing performed in the arrangement of FIG. 13 for acquiring target information is executed if response data cannot be generated on the side of the client machine. Thus, the optimum system configuration can readily be constructed on both the side of the service provider and the side of the service user by adopting the distributed configuration, and the optimum network service can be provided in response to the user request.

Though the present invention has been described in accordance with the foregoing embodiments, the invention is not limited thereto. For example, in the above embodiments, the structure of the data managed by the knowledge management unit 15 is as illustrated in FIGS. 15 to 17. However, this data structure does not impose a limitation upon the invention. Further, the present invention has been described in conjunction with information provider sites and users. However, this does not impose a limitation upon the invention, which can be applied to a variety of network service sites such as EC sites, financial service sites and amusement sites. Further, the input/output unit is not limited to that described in the above embodiments. Other devices, even devices that may appear anew in the future, can be supported.

Thus, in accordance with the present invention, target information can be acquired in simple manner by improving the man-machine interface used when network services are utilized. Further, operability is improved by reducing the number of operations or number of times requests are input to acquire target information, thereby preventing widening of the digital divide. Further, in accordance with the interactive browsing system according to the present invention, an information page can be created in simple manner in a manner similar to that heretofore without requiring creation of a user-aware information page. Further, target information can be acquired using the latest access-destination information. Moreover, target information can be output in an output format that takes into consideration the structure of input/output units of a browsing system as well as user information.

As many apparently widely different embodiments of the present invention can be made without departing from the spirit and scope thereof, it is to be understood that the invention is not limited to the specific embodiments thereof except as defined in the appended claims.

What is claimed is:

1. An information acquisition method for acquiring target information in a prescribed information page, which exists at a prescribed site on a network, in response to a request from a user, comprising the steps of:
storing knowledge necessary to acquire a keyword of a utilizable information page;
analyzing a request, which the user has entered, using the knowledge and extracting a keyword conforming to the user request; and
acquiring desired target information from the network using this keyword.

2. The method according to claim 1, further comprising a step of extracting a word, which is necessary to acquire a keyword of a prescribed information page, from a request entered by the user.

3. The method according to claim 2, wherein the knowledge includes knowledge for generating navigation that provides guidance appropriately until target information is acquired, and said method further comprises the steps of:
generating and outputting navigation, which is necessary to acquire a keyword, based upon knowledge relating to the first-mentioned navigation if a keyword of a prescribed information page cannot be acquired from the word extracted from the request entered by the user; and
acquiring a keyword by referring to a reply from the user in response to this generated navigation.

4. The method according to claim 3, further comprising a step of creating navigation, which indicates the gist of target information acquired from the network, and outputting this navigation together with the target information.

5. The method according to claim 2, further comprising a step of acquiring new knowledge whenever processing for acquiring the target information is executed, and appending this knowledge to knowledge acquired thus far.

6. The method according to claim 1, wherein the knowledge includes:
(1) user information having information relating to personal attributes, operating characteristics and operating history;
(2) access-destination information having hierarchical structure information of information pages inclusive of utilizable information pages and information pages of lower hierarchical layers, and keywords of these information pages;
(3) a dictionary of phrases, such as operating guidance or the like, necessary for interaction with the user; and
(4) a navigation template for generating navigation that provides guidance appropriately until the user acquires the target information;
said method further comprising a step of extracting a word, which is necessary to acquire a keyword of a prescribed information page, from a request entered by the user.

7. The method according to claim 6, further comprising a step of automatically acquiring the latest access-destination information from a prescribed site on the network, thereby updating old access-destination information, whenever target-information acquisition processing is executed, or at a timing specified by the user, or periodically.

8. The method according to claim 6, further comprising a step of converting the target information to an appropriate output format based upon the structure of apparatus employed by the user as well as the user information.

9. An interactive browsing system for performing control for acquiring target information in a prescribed information page, which exists at a prescribed site on a network, in response to a request from a user, comprising:
a knowledge management unit for storing knowledge necessary to acquire a keyword of a utilizable information page;
data conversion means for converting request data from the user to data necessary to acquire the keyword;
an agent for extracting a keyword of a prescribed information page, which is in compliance with the user request, using the knowledge and data obtained by the conversion; and
means for performing control for acquiring desired target information from the network using the keyword.

10. The system according to claim 9, wherein said data conversion means extracts a word, which is necessary to acquire the keyword of a prescribed information page, from the request data entered by the user, and said agent acquires the keyword, which is in compliance with the word, based upon the knowledge.

11. The system according to claim 10, wherein said knowledge management unit stores knowledge for generating navigation that provides guidance appropriately until the target information is acquired; and
if said agent cannot acquire the keyword of the prescribed information page from the word extracted from the request data, which has been entered by the user, and the knowledge, then said agent generates navigation necessary to acquire the keyword, outputs the navigation from an input/output unit and acquires the keyword by referring to a reply from the user in response to the navigation.

12. The system according to claim 11, wherein said knowledge management unit acquires new information whenever processing for acquiring the target information is executed, and appends this knowledge to knowledge acquired thus far.

13. The system according to claim 9, wherein said knowledge management unit, said data conversion means and said agent are all provided on the side of a user client machine.

14. The system according to any one of claims 9 to 12, wherein said knowledge management unit and said agent are provided in a server machine separate from a user client machine connected to the network.

15. The system according to claim 9, wherein said knowledge management unit and said agent are distributed by being respectively provided in both a user client machine connected to the network and a server machine separate from the client machine.

16. The system according to claim 9, wherein said knowledge management unit stores (1) user information having information relating to personal attributes, operating characteristics and operating history; (2) access-destination information having hierarchical structure information of information pages inclusive of utilizable information pages and information pages of lower hierarchical layers, and keywords of these information pages; (3) a dictionary of phrases, such as operating guidance or the like, necessary for interaction with the user; and (4) a navigation template for generating navigation that provides guidance appropriately until the user acquires the target information;
said data conversion means extracts a word, which is necessary to acquire the keyword of a prescribed information page, from the request data entered by the user; and
said agent acquires the keyword, which is in compliance with the word, based upon the knowledge.

17. The system according to claim 16, further comprising means for acquiring the latest access-destination information from a prescribed site on the network automatically whenever target-information acquisition processing is executed, or at a timing specified by the user, or periodically, wherein said knowledge management unit updates old access-destination information to the latest access-destination information.

18. The system according to claim 16, further comprising output-format conversion means for converting the target information to an appropriate output format based upon the structure of apparatus employed by the user as well as the user information.

19. A browsing system for acquiring desired information via a network from an information provider apparatus possessing information of a hierarchical structure, said system comprising:
means for directly acquiring a plurality of items of information situated hierarchically below information currently being acquired.
